(19) United States
(12) Patent Application Publication
(10) Pub. No.: US 2025/0062971 A1
(43) Pub. Date: Feb. 20, 2025

(54) RESTRICTED UE ASSISTANCE FOR MINIMIZATION OF DRIVE TEST AND QUALITY OF EXPERIENCE MEASUREMENT ALIGNMENT

(71) Applicant: QUALCOMM INCORPORATED, San Diego, CA (US)

(72) Inventors: Shankar Krishnan, Poway, CA (US); Jianhua Liu, Beijing (CN)

(21) Appl. No.: 18/720,581

(22) PCT Filed: Feb. 10, 2022
(86) PCT No.: PCT/CN2022/075775

§ 371 Date: Jun. 14, 2024

(51) Int. Cl. H04L 41/5067; H04W 24/08

(52) U.S. Cl. CPC H04L 41/5067; H04W 24/08

(57) ABSTRACT

Methods, systems, and devices for wireless communications are described. A user equipment (UE) may receive a first control message that includes a quality of experience (QoE) measurement configuration that indicates one or more QoE measurement references for the EE to perform and one or more indicator flags requesting a start indication and an end indication and an associated minimization of drive test (MDT) configuration to be aligned with the one or more QoE measurement references. The EE may transmit the start or end indication associated with the measurement session based on the indicator flag being set for the measurement session, and may receive a second control message that includes the MDT configuration for the EE to apply in addition to the QoE measurement references.

### CROSS REFERENCE

The present application is a 371 national stage filing of International PCT Application No. PCT/CN2022/075775 by Krishnan et al. entitled “RESTRICTED UE ASSISTANCE FOR MINIMIZATION OF DRIVE TEST AND QUALITY OF EXPERIENCE MEASUREMENT ALIGNMENT,” filed Feb. 10, 2022, which is assigned to the assignee hereof, and which is expressly incorporated by reference in its entirety herein.

### FIELD OF TECHNOLOGY

The following relates to wireless communications, including restricted user equipment assistance for minimization of drive test and quality of experience measurement alignment.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities or one or more network access nodes, each simultaneously supporting communication for multiple communication devices, which may be otherwise known as user equipment (UE).

Some wireless communications systems may support various techniques for user experience evaluation. Such techniques may increase performance for UE operations that utilize high date rate and low latency communications, such as streaming or video services.

### SUMMARY

The described techniques relate to improved methods, systems, devices, and apparatuses that support restricted user equipment (UE) assistance for minimization of drive test (MDT) and quality of experience (QoE) measurement alignment. Generally, the described techniques support techniques for aligning both QoE and MDT reporting performed by a UE. In some wireless communications networks, a UE may be configured to perform and transmit different quality reporting measurements that indicate signaling quality for one or more applications that the UE executes. In some implementations, both QoE and MDT may be performed during the same or similar time period, which reduces the likelihood that the UE performs and reports unnecessary or excessive measurements.

In some examples, the UE may implement different techniques to increase the efficiency of MDT and QoE reporting and to further enhance the granularity of UE assistance signaling to identify which QoE configurations to align with associated MDT configurations. The UE may receive control signaling that includes a number of QoE references and one or more indicator flags which request a start and end indication associated with a measurement session. In such cases, a TRUE valued flag may indicate an associated MDT configuration with the a corresponding QoE configuration, and a FALSE valued flag may indicate that the corresponding QoE configuration does not have an associated MDT configuration. Based on receiving a TRUE valued flag in the QoE configuration, the UE may transmit a start indication and an end indication, which may trigger the QoE-MDT alignment. Additionally or alternatively, the UE may refrain from sending a start indication and an end indication based on receiving a FALSE valued flag in the QoE configuration. In some other examples, the UE may transmit a single session start indication at the beginning of a first QoE measurement and may send a single end indication at the end of the last QoE measurement of a group of MDT aligned QoE measurements. In some other examples, the UE may send a UE capability message which indicates whether or not it is capable of sending QoE measurement session start/end indications to trigger QoE-MDT alignment.

A method for wireless communication at a UE is described. The method may include receiving a first control message including a QoE measurement configuration that indicates one or more QoE measurement references for the UE to perform and one or more indicator flags requesting a start indication and an end indication associated with a measurement session for the one or more QoE measurement references, transmitting the start indication associated with the measurement session for the one or more QoE measurement references based on an indicator flag of the one or more indicator flags being set for the measurement session, receiving, based on the start indication, a second control message including a MDT measurement configuration that indicates one or more MDT measurements for the UE to perform in addition to the one or more QoE measurement references, and transmitting the end indication associated with the measurement session based on performing measurements for the one or more QoE measurement references and the one or more MDT measurements.

An apparatus for wireless communication at a UE is described. The apparatus may include a processor, memory coupled with the processor, and instructions stored in the memory. The instructions may be executable by the processor to cause the apparatus to receive a first control message including a QE measurement configuration that indicates one or more QoE measurement references for the UE to perform and one or more indicator flags requesting a start indication and an end indication associated with a measurement session for the one or more QoE measurement references, transmit the start indication associated with the measurement session for the one or more QoE measurement references based on an indicator flag of the one or more indicator flags being set for the measurement session, receive, based on the start indication, a second control message including a MDT measurement configuration that indicates one or more MDT measurements for the UE to perform in addition to the one or more QoE measurement references, and transmit the end indication associated with the measurement session based on performing measurements for the one or more QoE measurement references and the one or more MDT measurements.

Another apparatus for wireless communication at a UE is described. The apparatus may include means for receiving a first control message including a QoE measurement configuration that indicates one or more QoE measurement references for the UE to perform and one or more indicator flags requesting a start indication and an end indication associated with a measurement session for the one or more QoE measurement references, means for transmitting the start indication associated with the measurement session for the one or more QoE measurement references based on an indicator flag of the one or more indicator flags being set for the measurement session, means for receiving, based on the start indication, a second control message including a MDT measurement configuration that indicates one or more MDT measurements for the UE to perform in addition to the one or more QoE measurement references, and means for transmitting the end indication associated with the measurement session based on performing measurements for the one or more QoE measurement references and the one or more MDT measurements.

A non-transitory computer-readable medium storing code for wireless communication at a UE is described. The code may include instructions executable by a processor to receive a first control message including a QoE measurement configuration that indicates one or more QoE measurement references for the UE to perform and one or more indicator flags requesting a start indication and an end indication associated with a measurement session for the one or more QoE measurement references, transmit the start indication associated with the measurement session for the one or more QoE measurement references based on an indicator flag of the one or more indicator flags being set for the measurement session, receive, based on the start indication, a second control message including a MDT measurement configuration that indicates one or more MDT measurements for the UE to perform in addition to the one or more QoE measurement references, and transmit the end indication associated with the measurement session based on performing measurements for the one or more QoE measurement references and the one or more MDT measurements.

Some examples of the method, apparatuses, and non-transitory computer-readable medium described herein may further include operations, features, means, or instructions for receiving a single indicator flag for a single QoE measurement reference and transmitting both the start indication and the end indication for the single QoE measurement reference in accordance with the single indicator flag.

Some examples of the method, apparatuses, and non-transitory computer-readable medium described herein may further include operations, features, means, or instructions for receiving the one or more indicator flags for a subset of the one or more QoE measurement references, the subset of the one or more QoE measurement references being associated with the one or more MDT measurements and transmitting both the start indication and the end indication for the subset of the one or more QoE measurement references in accordance with the received one or more indicator flags.

Some examples of the method, apparatuses, and non-transitory computer-readable medium described herein may further include operations, features, means, or instructions for receiving the one or more indicator flags for each of the one or more QoE measurement references and transmitting both the start indication and the end indication for each of the one or more QoE measurement references in accordance with the received one or more indicator flags.

Some examples of the method, apparatuses, and non-transitory computer-readable medium described herein may further include operations, features, means, or instructions for receiving a first indicator flag applicable to each of the one or more QoE measurement references and an second indicator flag applicable to a single QoE measurement reference of the one or more QoE measurement references and transmitting both the start indication and the end indication for each of the one or more QoE measurement references in accordance with the first indicator flag.

Some examples of the method, apparatuses, and non-transitory computer-readable medium described herein may further include operations, features, means, or instructions for transmitting the one or more indicator flags from an access stratum layer of the UE to an application layer of the UE via an attention command including the QoE measurement configuration based on receiving the one or more indicator flags from a network entity.

Some examples of the method, apparatuses, and non-transitory computer-readable medium described herein may further include operations, features, means, or instructions for transmitting both the start indication and the end indication from an application layer of the UE to an access stratum layer of the UE based on the received one or more indicator flags, where transmitting both the start indication and the end indication to a network entity may be based on transmitting the start indication and the end indication from the application layer of the UE to the access stratum layer of the UE.

In some examples of the method, apparatuses, and non-transitory computer-readable medium described herein, the start indication includes a QoE measurement collection (QMC) start indication and the end indication includes a QMC end indication and the method, apparatuses, and non-transitory computer-readable medium may include further operations, features, means, or instructions for transmitting the QMC start indication to indicate a set of QoE measurement references that may be associated with the one or more MDT measurements, performing the one or more the one or more QoE measurement references and the associated one or more MDT measurements in accordance with the QMC start indication, and transmitting the QMC end indication based on the performing.

Some examples of the method, apparatuses, and non-transitory computer-readable medium described herein may further include operations, features, means, or instructions for receiving an indication that the set of QoE measurement references may be associated with the one or more MDT measurements.

In some examples of the method, apparatuses, and non-transitory computer-readable medium described herein, the indication includes a MDT alignment message, a trace reference indication associated with the one or more MDT measurements, or both.

Some examples of the method, apparatuses, and non-transitory computer-readable medium described herein may further include operations, features, means, or instructions for transmitting the QMC start indication at a start of a first QoE measurement of the set, performing the one or more the one or more QoE measurement references and the one or more MDT measurements in accordance with the association, and transmitting the QMC end indication at a last QoE measurement of the set based on the association between the one or more QoE measurement references and the one or more MDT measurements.

Some examples of the method, apparatuses, and non-transitory computer-readable medium described herein may further include operations, features, means, or instructions for transmitting a UE capability message that indicates a capability of the UE to transmit the start indication, the end indication, or both.

In some examples of the method, apparatuses, and non-transitory computer-readable medium described herein, the first control message includes a first radio resource control (RRC) message.

Some examples of the method, apparatuses, and non-transitory computer-readable medium described herein may further include operations, features, means, or instructions for transmitting the start indication and the end indication via a UE application layer measurement report RRC message.

In some examples of the method, apparatuses, and non-transitory computer-readable medium described herein, the second control message includes a RRC reconfiguration message.

In some examples of the method, apparatuses, and non-transitory computer-readable medium described herein, the indicator flag includes a binary indicator and a value of the binary indicator associates the one or more QoE measurement references with the one or more MDT measurements.

A method for wireless communication at a network entity is described. The method may include transmitting a first control message including a QoE measurement configuration that indicates one or more QoE measurement references for a UE to perform and one or more indicator flags requesting a start indication and an end indication associated with a measurement session for the one or more QoE measurement references, receiving the start indication associated with the measurement session for the one or more QoE measurement references based on an indicator flag of the one or more indicator flags being set for the measurement session, transmitting, based on the start indication, a second control message including a MDT measurement configuration that indicates one or more MDT measurements for the UE to perform in addition to the one or more QoE measurement references, and receiving the end indication associated with the measurement session and a measurement report including the one or more QoE measurement references and the one or more MDT measurements.

An apparatus for wireless communication at a network entity is described. The apparatus may include a processor, memory coupled with the processor, and instructions stored in the memory. The instructions may be executable by the processor to cause the apparatus to transmit a first control message including a QoE measurement configuration that indicates one or more QoE measurement references for a UE to perform and one or more indicator flags requesting a start indication and an end indication associated with a measurement session for the one or more QoE measurement references, receive the start indication associated with the measurement session for the one or more QoE measurement references based on an indicator flag of the one or more indicator flags being set for the measurement session, transmit, based on the start indication, a second control message including a MDT measurement configuration that indicates one or more MDT measurements for the UE to perform in addition to the one or more QoE measurement references, and receive the end indication associated with the measurement session and a measurement report including the one or more QoE measurement references and the one or more MDT measurements.

Another apparatus for wireless communication at a network entity is described. The apparatus may include means for transmitting a first control message including a QoE measurement configuration that indicates one or more QoE measurement references for a UE to perform and one or more indicator flags requesting a start indication and an end indication associated with a measurement session for the one or more QoE measurement references, means for receiving the start indication associated with the measurement session for the one or more QoE measurement references based on an indicator flag of the one or more indicator flags being set for the measurement session, means for transmitting, based on the start indication, a second control message including a MDT measurement configuration that indicates one or more MDT measurements for the UE to perform in addition to the one or more QoE measurement references, and means for receiving the end indication associated with the measurement session and a measurement report including the one or more QoE measurement references and the one or more MDT measurements.

A non-transitory computer-readable medium storing code for wireless communication at a network entity is described. The code may include instructions executable by a processor to transmit a first control message including a QoE measurement configuration that indicates one or more QoE measurement references for a UE to perform and one or more indicator flags requesting a start indication and an end indication associated with a measurement session for the one or more QoE measurement references, receive the start indication associated with the measurement session for the one or more QoE measurement references based on an indicator flag of the one or more indicator flags being set for the measurement session, transmit, based on the start indication, a second control message including a MDT measurement configuration that indicates one or more MDT measurements for the UE to perform in addition to the one or more QoE measurement references, and receive the end indication associated with the measurement session and a measurement report including the one or more QoE measurement references and the one or more MDT measurements.

Some examples of the method, apparatuses, and non-transitory computer-readable medium described herein may further include operations, features, means, or instructions for transmitting a single indicator flag for a single QoE measurement reference and receiving both the start indication and the end indication for the single QoE measurement reference in accordance with the single indicator flag.

Some examples of the method, apparatuses, and non-transitory computer-readable medium described herein may further include operations, features, means, or instructions for transmitting the one or more indicator flags indicating a subset of the one or more QoE measurement references being associated with the one or more MDT measurements and receiving both the start indication and the end indication for the subset of the one or more QoE measurement references in accordance with the received one or more indicator flags.

Some examples of the method, apparatuses, and non-transitory computer-readable medium described herein may further include operations, features, means, or instructions for transmitting the one or more indicator flags for each of the one or more QoE measurement references and receiving both the start indication and the end indication for each of the one or more QoE measurement references in accordance with the received one or more indicator flags.

Some examples of the method, apparatuses, and non-transitory computer-readable medium described herein may further include operations, features, means, or instructions for transmitting a first indicator flag applicable to each of the one or more QoE measurement references and an second indicator flag applicable to a single QoE measurement reference of the one or more QoE measurement references and receiving both the start indication and the end indication for each of the one or more QoE measurement references in accordance with the first indicator flag.

In some examples of the method, apparatuses, and non-transitory computer-readable medium described herein, the start indication includes a QoE measurement collection (QMC) start indication and the end indication includes a QMC end indication and the method, apparatuses, and non-transitory computer-readable medium may include further operations, features, means, or instructions for receiving the QMC start indication that indicates an association between a set of QoE measurement references and the one or more MDT measurements and receiving the QMC end indication and the measurement report based on the association.

Some examples of the method, apparatuses, and non-transitory computer-readable medium described herein may further include operations, features, means, or instructions for transmitting an indication that the set of QoE measurement references may be associated with the one or more MDT measurements.

In some examples of the method, apparatuses, and non-transitory computer-readable medium described herein, the indication includes a MDT alignment message, a trace reference indication associated with the one or more MDT measurements, or both.

Some examples of the method, apparatuses, and non-transitory computer-readable medium described herein may further include operations, features, means, or instructions for receiving the QMC start indication at a start of a first QoE measurement of the set and receiving the QMC end indication at a last QoE measurement of the set based on the association between the one or more QoE measurement references and the one or more MDT measurements.

Some examples of the method, apparatuses, and non-transitory computer-readable medium described herein may further include operations, features, means, or instructions for receiving a UE capability message that indicates a capability of the UE to transmit the start indication, the end indication, or both.

In some examples of the method, apparatuses, and non-transitory computer-readable medium described herein, the first control message includes a first RRC message.

Some examples of the method, apparatuses, and non-transitory computer-readable medium described herein may further include operations, features, means, or instructions for receiving the start indication and the end indication via a UE application layer measurement report RRC message.

In some examples of the method, apparatuses, and non-transitory computer-readable medium described herein, the second control message includes a RRC reconfiguration message.

In some examples of the method, apparatuses, and non-transitory computer-readable medium described herein, the indicator flag includes a binary indicator and a value of the binary indicator associates the one or more QoE measurement references with the one or more MDT measurements.

### BRIEF DESCRIPTION OF THE DRAWINGS

FIGS. 1 and 2 illustrate example wireless communications systems that support restricted user equipment (UE) assistance for minimization of drive test (MDT) and quality of experience (QoE) measurement alignment in accordance with aspects of the present disclosure.

FIG. 3 illustrates an example of a process flow that supports restricted UE assistance for MDT and QoE measurement alignment in accordance with aspects of the present disclosure.

FIGS. 4A and 4B illustrate example QoE reporting timelines that support restricted UE assistance for MDT and QoE measurement alignment in accordance with aspects of the present disclosure.

FIGS. 5 and 6 show block diagrams of devices that support restricted UE assistance for MDT and QoE measurement alignment in accordance with aspects of the present disclosure.

FIG. 7 shows a block diagram of a communications manager that supports restricted UE assistance for MDT and QoE measurement alignment in accordance with aspects of the present disclosure.

FIG. 8 shows a diagram of a system including a device that supports restricted UE assistance for MDT and QoE measurement alignment in accordance with aspects of the present disclosure.

FIGS. 9 and 10 show block diagrams of devices that support restricted UE assistance for MDT and QoE measurement alignment in accordance with aspects of the present disclosure.

FIG. 11 shows a block diagram of a communications manager that supports restricted UE assistance for MDT and QoE measurement alignment in accordance with aspects of the present disclosure.

FIG. 12 shows a diagram of a system including a device that supports restricted UE assistance for MDT and QoE measurement alignment in accordance with aspects of the present disclosure.

FIGS. 13 through 17 show flowcharts illustrating methods that support restricted UE assistance for MDT and QoE measurement alignment in accordance with aspects of the present disclosure.

### DETAILED DESCRIPTION

Some wireless communications systems may support assistance reporting from user equipment (UE) to increase both network performance and UE performance by quality of experience (QoE) and minimization of drive test (MDT) reporting by the UE. For example, the UE may be configured to periodically send different quality reporting measurements to the network that indicate signaling quality for one or more applications that the UE is executing at a given time. In some cases, these measurements may be aligned so that both QoE and MDT can be performed during the same or similar time period, which may reduce the likelihood that the UE performs and reports unnecessary or excessive measurements. In some implementations, the transmission of such UE assistance reporting may be restricted such that the QoE and MDT reporting is coordinated to further save radio resources.

In some examples, the network may correlate an MDT configuration with an associated QoE configuration. For example, a network entity may receive an MDT trace ID in a QoE configuration, which indicates that the QoE configuration is to be aligned with an MDT configuration. The network may transmit the QoE configuration to the UE, and the UE may transmit a UE assistance message (e.g., a QoE measurement session start indication) which notifies the network that the UE has started an application and is going to perform QoE measurements. Similarly, the UE may send an additional assistance message (e.g., a QoE measurement session end indication) which indicates that the UE has ended the application. This QoE measurement session start indication or QoE session end indication may trigger the network to configure the associated MDT configuration with the QoE measurement session such that the UE may align its QoE and MDT measurements during the QoE measurement session.

In some cases, however, the UE may be configured with many QoE measurements or QoE references indicated by the QoE configuration, and not all of these QoE measurements have associated MDT configurations or measurements. In such cases, the UE may transmit the QoE session start or end indications blindly for all QoE configurations and for all associated QoE measurements, even for those that are not to be aligned with any MDT configuration. Such techniques may introduce unnecessary signaling overhead and may reduce the efficiency of QoE and MDT alignment by using up RRC radio resources for the unnecessary signaling.

In some cases, the UE may implement a quantity of different techniques to increase the efficiency of MDT and QoE reporting and to further enhance the granularity of UE assistance signaling to identify which QoE configurations to align with associated MDT configurations. In some examples, the network entity may include a flag along with each QoE measurement reference in a QoE measurement configuration. If the flag=TRUE, the UE may transmit an associated session start indication and a session end indication to align the QoE configuration with an associated MDT configuration. If the flag associated with the QoE measurement reference is FALSE, then the UE may refrain from sending a session start indication and the session stop indication, and QoE-MDT alignment may not occur. In such flag-based techniques, the session start indication and the session end indication is not sent unnecessarily for QoE configurations for which MDT-QoE alignment is not indicated.

In some other techniques, the UE may determine that a group of or more QoE measurements are to be aligned with respective MDT configurations. In such cases, the UE may transmit a single session start indication at the beginning of the first QoE measurement and may send a single end indication at the end of the last QoE measurement of the group. In some other examples, the UE may send a UE capability message which indicates whether it is capable of sending QoE measurement session start indications and QoE measurement session end indications to trigger QoE-MDT alignment.

Aspects of the disclosure are initially described in the context of wireless communications systems. Aspects of the disclosure are further illustrated by and described with reference to apparatus diagrams, system diagrams, a process flow, timing diagrams, and flowcharts that relate to restricted UE assistance for MDT and QoE measurement alignment.

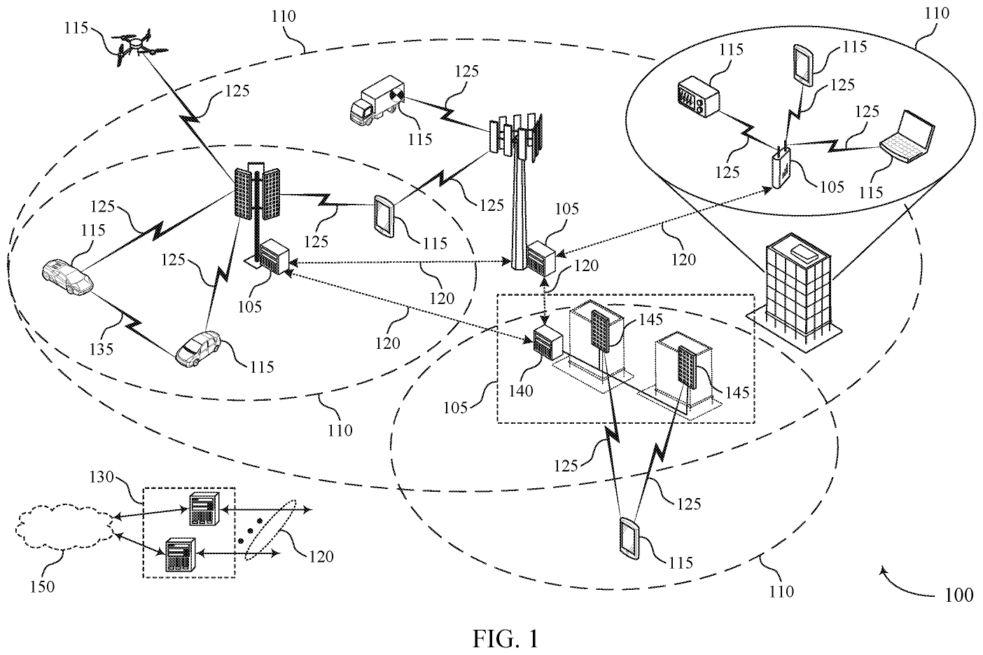

FIG. 1 illustrates an example of a wireless communications system 100 that supports restricted UE assistance for MDT and QoE measurement alignment in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The network entities 105 may be dispersed throughout a geographic area to form the wireless communications system 100 and may be devices in different forms or having different capabilities. The network entities 105 and the UEs 115 may wirelessly communicate via one or more communication links 125. Each network entity 105 may provide a coverage area 110 over which the UEs 115 and the network entity 105 may establish one or more communication links 125. The coverage area 110 may be an example of a geographic area over which a network entity 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the network entities 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, network entity 105, entity of a core network 130, apparatus, device, or computing system configured to perform any techniques described herein. For example, a network node may be a UE 115. As another example, a network node may be a network entity 105. As another example, a first network node may be configured to communicate with a second network node or a third network node. In one aspect of this example, the first network node may be a UE 115, the second network node may be a network entity 105, and the third network node may be a UE 115. In another aspect of this example, the first network node may be a UE 115, the second network node may be a network entity 105, and the third network node may be a network entity 105. In yet other aspects of this example, the first, second, and third network nodes may be different. Similarly, reference to a UE 115, a network entity 105, an apparatus, a device, or a computing system may include disclosure of the UE 115, network entity 105, apparatus, device, or computing system being a network node. For example, disclosure that a UE 115 is configured to receive information from a network entity 105 also discloses that a first network node is configured to receive information from a second network node. In this example, consistent with this disclosure, the first network node may refer to a first UE 115, a first network entity 105, a first apparatus, a first device, or a first computing system configured to receive the information; and the second network node may refer to a second UE 115, a second network entity 105, a second apparatus, a second device, or a second computing system.

The network entities 105 may communicate with the core network 130, or with one another, or both. For example, the network entities 105 may interface with the core network 130 through one or more backhaul links 120 (e.g., via an S1, N2, N3, or other interface). The network entities 105 may communicate with one another over the backhaul links 120 (e.g., via an X2, Xn, or other interface) either directly (e.g., directly between network entities 105), or indirectly (e.g., via core network 130), or both. In some examples, the backhaul links 120 may be or include one or more wireless links.

One or more of the network entities 105 described herein may include or may be referred to by a person having ordinary skill in the art as a base transceiver station, a radio network entity, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay network entities, among other examples, as shown in FIG. 1.

The UEs 115 and the network entities 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a network entity 105, or downlink transmissions from a network entity 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 may be movable and therefore provide communication coverage for a moving geographic coverage area 110. In some examples, different geographic coverage areas 110 associated with different technologies may overlap, but the different geographic coverage areas 110 may be supported by the same network entity 105. In other examples, the overlapping geographic coverage areas 110 associated with different technologies may be supported by different network entities 105. The wireless communications system 100 may include, for example, a heterogeneous network in which different types of the network entities 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a network entity 105. Other UEs 115 in such a group may be outside the geographic coverage area 110 of a network entity 105 or be otherwise unable to receive transmissions from a network entity 105. In some examples, groups of the UEs 115 communicating via D2D communications may utilize a one-to-many (1:M) system in which each UE 115 transmits to every other UE 115 in the group. In some examples, a network entity 105 facilitates the scheduling of resources for D2D communications. In other cases, D2D communications are carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network entities, such as a network entity 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or network entity 105 may be distributed across various network entities (e.g., radio heads and ANCs) or consolidated into a single network entity (e.g., a network entity 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more network entity antennas or antenna array's may be co-located at an antenna assembly, such as an antenna tower. In some examples, antennas or antenna arrays associated with a network entity 105 may be located in diverse geographic locations. A network entity 105 may have an antenna array with a number of rows and columns of antenna ports that the network entity 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a network entity 105 or a core network 130 supporting radio bearers for user plane data. At the physical layer, transport channels may be mapped to physical channels.

Wireless communications network 100 may support QoE measurement collection, which may include the activation of measurement collection by a UE 115 and reporting of the collected information. The parameters for a network request session are sent from a management system to the RNCs that host the cells that are included in the collection job request in an activateAreaQMCJob operation. The network starts a network request session, with the network request session id given in activateAreaQMCJob operation. For the duration of the network request session, the network checks for connections where the UE 115 has the UE Application Layer Measurement Capability. The UE Application Layer Measurement Capability is sent from the UE to an RNC (via the core network) in message INITIAL UE MESSAGE. When a session is found that has a UE 115 with the UE Application Layer Measurement Capability, the RNC starts a UE request session by sending a MEASUREMENT CONTROL message to the UE 115.

The AT command +CAPPLEVMC activates provisioning of measurement reporting from the lower layers to the application within the UE 115 by an unsolicited result code +CAPPLEVMC. When information about a measurement report is received in the UE 115 from the network, the unsolicited result code +CAPPLEVMC contains the relevant parameters (service_type, start_stop-indication and config-file and config-file length if applicable) that are provided from the lower layers in the UE 115 to the application. To initiate measurement reporting, the network may transmit a activateAreaQMCJob (including parameters serviceType, areaScope, qoECollectionEntityAddress, pLMNTarget, qMCTarget, qoEReference and a QMC configuration file). The network may forward the activateAreaQMCJob to impacted RNC(s).

The RNC may then check for connections where the UE 115 has the UE Application Layer Measurement Capability that match the criteria for serviceType in the activateAreaQMCJob. When a connection is found that has the UE Application Layer Measurement Capability, the RNC may start a UE request session, store the associated QoECollectionEntityAddress, and send the message RRCConnectionReconfiguration to the UE 115, which includes the parameters serviceType, qoEReference and QMC configuration file.

The AS in the UE 115 may send the AT command +CAPPLEVMC to the application level, which may include the parameters serviceType, qoEReference and QMC configuration file. When the application in the serviceType starts, the QMC is initiated.

The application layer may send the AT command +CAPPLEVMR including a recording session indication that a session has started to the access stratum. The UE sends the message MeasurementReport including the recording session indication to the RNC, and the RNC sends a notification including the recording session indication to the network. When the QMC is completed, the recorded information is collected in a QMC report including qoEReference and recordingSessionId. The qoEReference, additional information may be collected for post processing purposes. The application layer may then send the AT command +CAPPLEVMR including qoEReference and the QMC report to the access stratum. The UE sends the message MeasurementReport including qoEReference and the QMC report to the RNC, and the RNC sends the QMC report to the entity associated to the qoEReference.

Wireless communications system 100 may support both QoE and MDT reporting performed by a UE 115. For example, the UE 115 may be configured to periodically send different quality reporting measurements to a network entity 105, which indicates signaling quality for one or more applications that the UE 115 is executing at a given time. In some cases, these measurements may be aligned so that both QoE and MDT can be performed during the same or similar time period, which may reduce the likelihood that the UE 115 performs and reports unnecessary or excessive measurements.

In some examples, the network may correlate an MDT configuration with an associated QoE configuration. In some cases, however, the UE 115 may be configured with many QoE measurements or QoE references indicated by the QoE configuration, with some, but not all, of these QoE measurements being associated with MDT measurements. In such cases, the UE 115 may transmit the QoE session start or end indications blindly for all QoE configurations and for all associated QoE measurements, even for those that are not to be aligned with any MDT configuration.

In some cases, the UE 115 may implement a quantity of different techniques to increase the efficiency of MDT and QoE reporting and to further enhance the granularity of UE 115 assistance signaling to identify which QoE configurations to align with associated MDT configurations. In some examples, the network entity 105 may include a flag along with each QoE measurement reference in a QoE measurement configuration. If the flag=TRUE, then the UE 115 may transmit a session start indication and a session end indication for the QoE measurement to align the QoE reference with an associated MDT. If the flag associated with the QoE measurement reference is FALSE, the UE 115 may refrain from sending a session start indication or a session stop indication, and QoE-MDT alignment may not occur. In some techniques, the UE 115 may transmit a single session start indication at the beginning of a first QoE measurement and may send a single end indication at the end of the last QoE measurement of the group. In some other examples, the UE 115 may send a UE capability message which indicates whether or not it is capable of sending QoE measurement session start/end indications to trigger QoE-MDT alignment

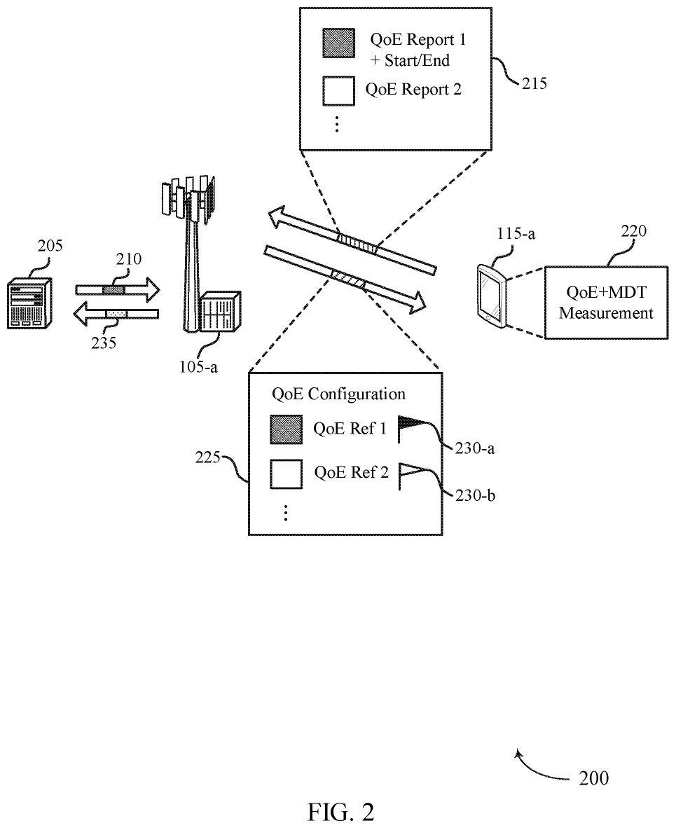

FIG. 2 illustrates an example of a wireless communications system 200 that supports restricted UE assistance for MDT and QoE measurement alignment in accordance with aspects of the present disclosure. For example, wireless communications system may support signaling between a UE 115-a and network entity 105-a, which may be in further communication with an operations, administration, and maintenance (OAM) entity 205. The OAM entity may include one or more network entities configured to perform the functions of the OAM entity 205. These devices may be examples of corresponding devices described with reference to FIG. 1.

Wireless communications system 200 may support UE assistance reporting (in the form of QoE and MDT reporting) to increase both network performance and UE performance by increasing throughput and service quality, reducing or mitigating interference, increasing the efficiency of cell reselection, and other performance enhancements. The UE 115-a may be configured to periodically send different quality and power reporting measurements to the network (e.g., to a network entity 105-a or another network entity) so that the network can assess channel quality and overall performance of the UE 115-a. For example, the UE 115-a may transmit both QoE measurement reports and MDT measurement reports to the network, which in some cases may be related to the quality of the application executed by the UE 115-a. In some cases, these measurements may be aligned so that both QoE and MDT can be performed during the same time period, which reduces the chance that the UE 115-a performs unnecessary or excessive measurements, and reduces the chances that the UE 115-a reports unnecessary measurements. Additionally or alternatively, in some implementations the transmission of such UE assistance reporting may be restricted such that the QoE and MDT reporting is coordinated to further save radio resources.

In some examples, the network entity 105-a may correlate an MDT configuration with an associated QoE configuration based on receiving an indicator in a QoE configuration message sent from the OAM entity 205. For example, the network entity 105-a may receive an MDT trace ID 210 in the QoE configuration from the OAM entity 205. To trigger an aligned QoE and MDT session, the UE 115-a may transmit a UE assistance message (e.g., a QoE measurement session start indication) which indicates a flag for the network that the UE has started an application and is going to perform QoE measurements. Similarly, the UE 115-a may send an additional assistance message (e.g., a QoE measurement session end indication) which indicates that the UE 115-a has ended the application. This QoE measurement session start indication or QoE session end indication may trigger the network to configure an associated MDT configuration with the QoE measurement session such that the UE 115-a can align its QoE and MDT measurements during the QoE measurement session 220. Then, the UE 115-a may deactivate the MDT configuration by sending a QoE measurement session end indication to the network. In some other examples, the OAM entity 205 and network entity 105-a may align MDT and QoE measurement collection (QMC) such that the OAM includes the MDT trace reference and trace recording session reference of the MDT configuration, or the trace reference of the MDT configuration, in the QoE configuration transmitted to the network entity 105-a.

In some cases, however, the UE 115-a may be configured with many QoE measurements or QoE references indicated by the QoE configuration (or QoE configurations, as the case may be), and not all of these QoE measurements have associated MDT measurements. In some implementations, the UE 115-a may transmit the QoE session start or end indications blindly for all QoE configurations and for all associated QoE measurements, even for those that are not to be aligned with any MDT configuration. Such techniques may introduce unnecessary signaling overhead and may reduce the efficiency of QoE and MDT alignment by using RRC resources for the signaling.

The wireless communications system 200 may implement a number of different techniques to increase the efficiency of MDT and QoE reporting and to further enhance the granularity of UE assistance signaling to identify which QoE measurements to align with associated MDT configurations. In some examples, the network entity 105-a may include a flag 230 along with each QoE measurement reference 1 in a QoE measurement configuration 225. If the flag=TRUE (e.g., flag 230-a), then the UE 115-a will transmit an associated session start/end indication at 215 with the corresponding QoE report 1 to the network entity 105-a to align the QoE reference 1 with MDT. If the flag associated with the QoE measurement reference 2 is FALSE (e.g., flag 230-b), then the UE 115-a will refrain from sending a session start/stop indication at 215 with the QoE measurement report 2, and the network entity 105-a will refrain from aligning MDT with the QoE measurements of QoE report 2. The network entity 105-a may then transmit the QoE report 1 and the QoE report 2 to the OAM entity 205 at 235. In such flag-based techniques, the session start/end indication is not sent unnecessarily for QoE configurations for which MDT-QoE alignment is not indicated (e.g., as for QoE measurement reference 2).

In some other techniques, the UE 115-a may determine (or may receive signaling from the network that indicates) that a group of one or more QoE measurements are to be aligned with respective MDT configurations. In such cases, the UE 115-a may transmit a single session start indication at the beginning of the first QoE measurement and may send a single end indication at the end of the last QoE measurement of the group. The UE 115-a may be configured by the network to align some or all of the QoE measurements with associated MDT measurements that occur between the start and end indications. In some other examples, the UE 115-a may send a UE capability message which indicates whether or not it is capable of sending QoE measurement session start/end indications to trigger QoE-MDT alignment. In such examples, the network may not expect the UE 115-a to indicate the QoE start/end indication if the UE 115-a does not support the QoE-MDT alignment.

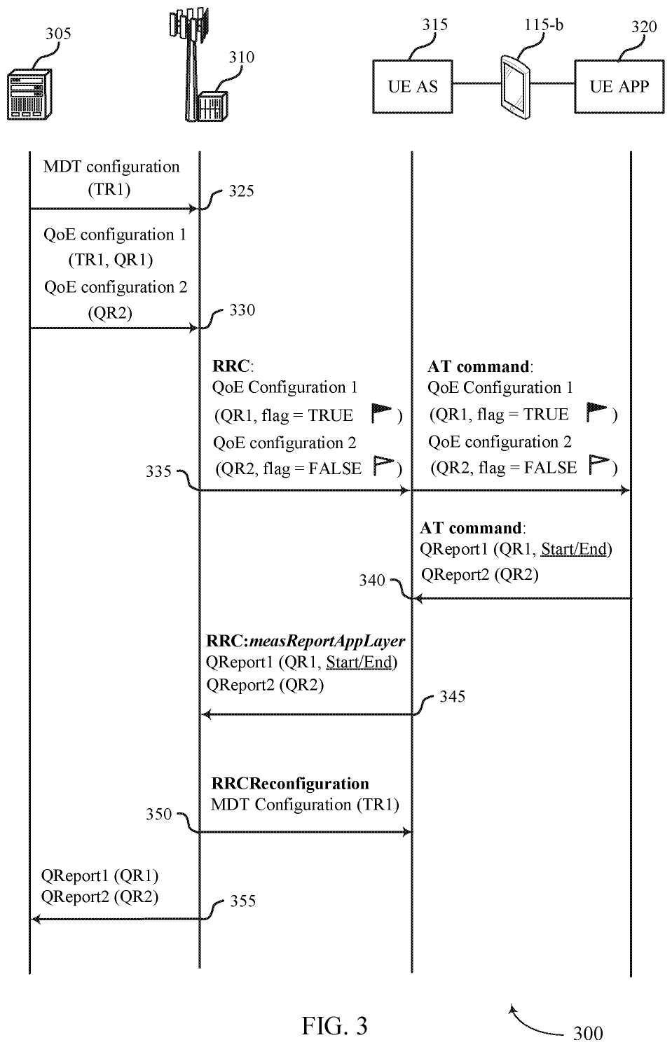

FIG. 3 illustrates an example of a process flow 300 that supports restricted UE assistance for MDT and QoE measurement alignment in accordance with aspects of the present disclosure. The process flow 300 may implement aspects of wireless communications systems 100 and 200, or may be implemented by aspects of the wireless communications systems 100 and 200. For example, the process flow 300 may illustrate operations between a UE 115-b, a network entity or next generation-radio access network (NG-RAN) 310, and an OAM 305, which may be examples of corresponding devices described with reference to FIGS. 1 and 2. In the following description of the process flow 300, the operations between the devices may be transmitted in a different order than the example order shown, or the operations may be performed in different orders or at different times or by different devices. Additionally or alternatively, some operations may also be omitted from the process flow 300, and other operations may be added to the process flow 300.

At 325, the OAM 305 may transmit, and the NG-RAN 310 may receive, an MDT configuration to the NG-RAN 310, which may be an example of a network entity 105 or another network entity described with reference to FIGS. 1 and 2. The MDT configuration may include a first trace reference (e.g., TR1) which indicates the MDT configuration. The NG-RAN 310 may keep the MDT configuration in a pending state until receiving a start or end indication from the UE 115-a.

At 330, the OAM 305 may transmit, and the NG RAN 310 may receive, a first QoE configuration (e.g., QoE configuration 1 to the NG-RAN 310, which may include a first QoE measurement reference (e.g., QR1) and the MDT trace reference (TR1). In some examples, the transmission of both QR1 and TR1 may indicate an alignment of the first QoE measurement reference and the MDT configuration. The OAM 305 may also transmit a second QoE configuration which includes a second QoE measurement reference (QR2). In some examples, the second QoE measurement reference may not be associated with a corresponding MDT configuration.

At 335, the NG-RAN 310 may transmit, and the UE 115-b may receive (at an access stratum (AS) layer of the UE 115-b), control signaling, such as an RRC message (e.g., an RRCConnectionReconfiguration message), which includes the first and second QoE configurations. In some examples, the NG-RAN 310 may include one or more flags associated with the first and second QoE configurations sent to UE 115-b which indicate that the UE 115-b is to send a QoE measurement session start/end indication for that QoE configuration (identified by a QoE measurement reference). For example, the NG-RAN 310 may indicate an associated MDT configuration with the first QoE measurement reference (QR1) by including a TRUE flag in the QoE configuration 1. The NG-RAN 310 may also indicate that no MDT configurations are associated with the second QoE measurement reference (QR2) in the second QoE configuration by including a FALSE flag with QR2.

The UE AS 315 may relay or pass on the first and second QoE configurations and associated flags to the UE application layer 320 (e.g., UE APP 320) using an attention command (e.g., AT command) message.

At 340, the UE APP 320 may receive the first and second QoE configurations and associated flags and may perform QoE measurements in accordance with the QoE configurations. The UE APP 320 may send a first QoE report (e.g., QReport1) associated with the first QoE configuration via an AT command message to the UE AS 315. In the first QoE report, the UE APP 320 may include a QoE session start/end indication (e.g., start/end) along with the first QoE measurement reference (e.g., QR1) to indicate MDT alignment for the QR1 based on receiving the TRUE flag. In addition, the UE APP 320 may transmit a second QoE report (e.g., QReport2) associated with the second QoE configuration via the AT command message to the UE AS 315. In the second QoE report, the UE APP 320 may not include a QoE session start/end indication along with the second QoE measurement reference (e.g., QR2) to indicate no MDT alignment for the QR2 based on the FALSE flag.

At 345, the UE AS 315 may relay or transmit the first QoE report (e.g., QReport1) including the QoE session start/end indication along with the first QoE measurement reference (e.g., QR1) to indicate MDT alignment for the QR1 based on receiving the TRUE flag. In addition, the UE AS 315 may relay or transmit the second QoE report (e.g., QReport2) associated with the second QoE configuration which includes the second QoE measurement reference (e.g., QR2) to indicate no MDT alignment for the QR2 based on the FALSE flag. In some examples, the UE AS 315 may transmit the first and second QoE reports, QR1, QR2, and the associated start/end indication via an RRC message (e.g., an RRC measReportAppLayer message). In such examples, based on the received TRUE/FALSE flags, the session start/end indication is not sent unnecessarily for QoE configurations for which MDT-QoE alignment is not to be performed (e.g., for QoE configuration 2).

At 350, based on receiving the start/end indication for the first QoE configuration, the NG-RAN 310 may transmit a control message (e.g., an RRCConnectionReconfiguration message) which includes the MDT configuration and the MDT trace reference (e.g., TR1) that the UE 115-b may use to perform MDT measurements aligned with the QoE measurements associated with QR1 and the first QoE configuration.

In some implementations, the NG-RAN 310 may include a number of different flags in the control message sent to the UE AS 315 at 335. In a first example, a flag may be a configuration-specific flag that is associated with a specific QoE configuration, which indicates that UE 115-b may send the QoE measurement session start/end indication for that QoE configuration (identified by a QoE measurement reference). In a second example, the configuration-specific flag may be for those QoE configurations for which MDT-QoE alignment is desired (e.g., indicated by Trace Reference and Trace Recording Session Reference in the QoE configuration sent from OAM 305). In a third example, the flag may be a generic flag for all QoE configurations, which indicates that UE 115-b may send a QoE measurement session start/end indication for all QoE configurations (e.g., QoE configurations 1 and 2) regardless of whether there is an associated MDT configuration. In such examples, if the generic flag is set, then the session-specific flag may not to be included in the QoE configuration or may be ignored by the UE 115-b if it is included (e.g., due to an incorrect network configuration or other factors). In other examples, if the configuration-specific flag is set, then the generic flag may not be included in the QoE configurations or may be ignored by the UE 115-b for the configurations that that have the configuration-specific flag.

In some other implementations, the UE AS 315 may indicate either of the two flags in the QoE configurations sent to UE APP 320 in the AT message (e.g., AT command +CAPPLEVMC) used for delivering the QoE configurations at 335. In some examples, the UE APP 320 may transmit the session start/indication for those QoE configurations for which the configuration-specific flag is set in the AT message (e.g., AT command +CAPPLEVMR) used for delivering the QoE reports. In some other examples, the UE App 320 may send the session start/end indication for the QoE configurations if the generic flag is set in the AT message (e.g., AT command +CAPPLEVMR) used for delivering the QoE report.

At 355, the NG-RAN 310 may relay or transmit the first QoE report and the first QoE measurement reference (QR1) along with the second QoE report and the second QoE measurement reference (QR2) received from the UE AS 315, to the OAM 305.

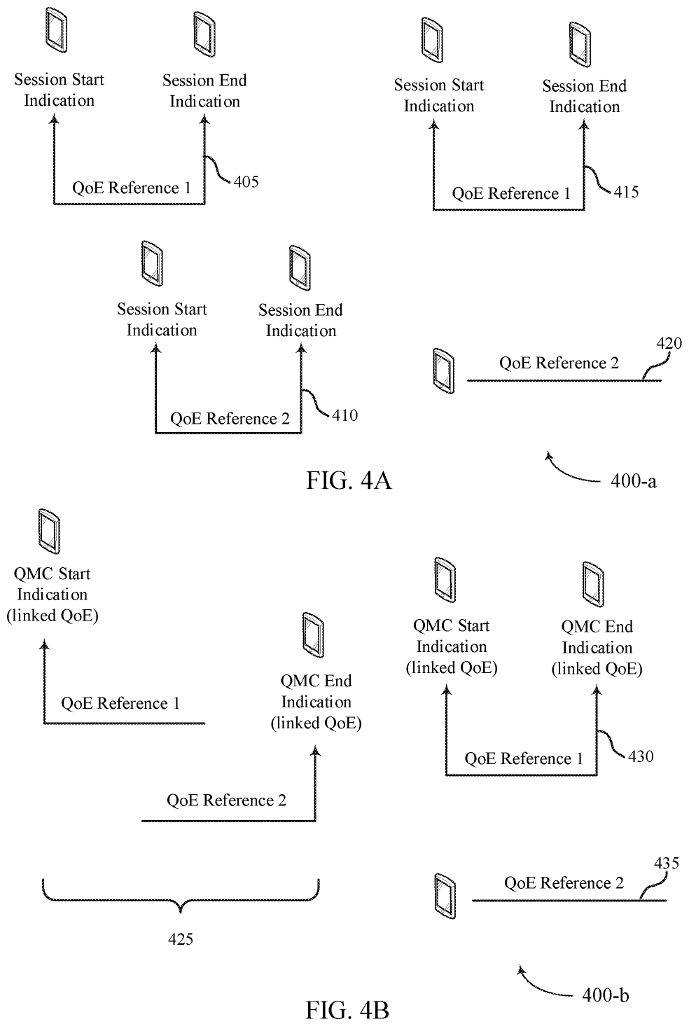

FIGS. 4A and 4B illustrate an example QoE reporting timelines 400-a and 400-b that support restricted UE assistance for MDT and QoE measurement alignment in accordance with aspects of the present disclosure. The QoE reporting timelines 400-a and 400-b may be implemented at or by may wireless devices such as a UE, a network entity or NG-RAN, an OAM, or any combination thereof, each of which may be examples of corresponding devices described with reference to FIGS. 1 through 3.

FIG. 4A shows example QoE reporting timelines 400-a for receiving QoE references and respective session start and end indications for aligning QoE and MDT measurements. In some cases, the timelines 400-a may represent QoE and MDT alignments that implement the flag-based solution described with reference to FIGS. 2 and 3. For example, in a first case corresponding to timelines 405 and 410, both QoE configurations (e.g., QoE reference 1 and QoE reference 2) are to be aligned with MDT. In such examples, the first QoE reference (e.g., QoE Ref 1) may be associated with a first MDT trace reference (e.g., Trace ID 1) and the second QoE reference (e.g., QoE Ref 2) may be associated the first MDT trace reference 1 (e.g., Trace ID 1). In addition, the first QoE reference and the second QoE reference may be associated with TRUE flags transmitted by the network. At 405, a UE may transmit a session start indication and a session end indication to the network (based on receiving a TRUE flag) to initiate QoE-MDT alignment for the QoE reference 1. Similarly, at 410, the UE may transmit a session start indication and a session end indication to the network (based on receiving a TRUE flag) to initiate QoE-MDT alignment for the QoE reference 2.

In a second case corresponding to timelines 415 and 420, the first QoE configuration (e.g., QoE reference 1) is to be aligned with MDT, and the second QoE configuration (e.g., QoE reference 2) may not be aligned with an MDT. In such examples, the first QoE reference (e.g., QoE Ref 1) may be associated with a first MDT trace reference (e.g., Trace ID 1) and the second QoE reference (e.g., QoE Ref 2) may not have an associated MDT configuration. In addition, the first QoE reference may be associated with a TRUE flag transmitted by the network, while the second QoE reference may be associated with a FALSE flag. At 415, a UE may transmit a session start indication and a session end indication to the network (based on receiving a TRUE flag) to initiate QoE-MDT alignment for the QoE reference 1. At 420, the UE may transmit only QoE reference 2 (based on receiving the FALSE flag).

FIG. 4B shows example QoE reporting timelines 400-b for receiving QoE references and respective session start and end indications for aligning QoE and MDT measurements. In some cases, the timelines 400-a may represent QoE and MDT alignments that implement a QMC start/end technique which may support linking a number of QoEs and associated start/end indications. For example, in a first case corresponding to the timeline 425, both QoE configurations (e.g., QoE reference 1 and QoE reference 2) are to be aligned with MDT. In such examples, the UE may determine that the first QoE reference and the second QoE reference both are to be aligned with MDT. The UE may determine to send a QMC start indication for the first QoE reference, at the start of the first QoE session and then may transmit a QMC end indication for the second QoE reference after the end of the second QoE session. The network may then align MDT with both the QoE reference 1 and the QoE reference 2 based on receiving the QMC start and end indications. In such cases, a QMC end indication may not be transmitted for the first QoE reference and a QMC start indication may not be transmitted for the second QoE reference.

In a second case corresponding to timelines 430 and 435, the UE may indicate a “QMC start/end indication for all linked QoEs” (e.g., instead of a session start/end indication described with reference to FIG. 4A). In such cases the UE may not send session start/end indications for each QoE Reference, but instead may transmit a single indication during a QMC start and one indication during the QMC end. In such examples, the UE may determine which QoE configurations are to be aligned with MDT in order to correctly determine the QMC start/end for all linked QoE. For example, in some cases the network (e.g., NG-RAN) may transmit an indication for the UE which indicates the linked QoE configurations. This indication may be a flag (e.g., “Alignment with MDT needed”), or the indication may be a trace reference of the linked MDT configuration in the QoE configuration.

At 430, the UE may determine a number of linked QoEs associated with QoE reference 1 and may transmit corresponding QMC start and end indications for the linked QoEs. Then, the UE may align the linked QoEs using respective MDT configurations. In some examples, the QoE reference may not be part of the linked QoEs, and may not be aligned with the respective MDT configurations.

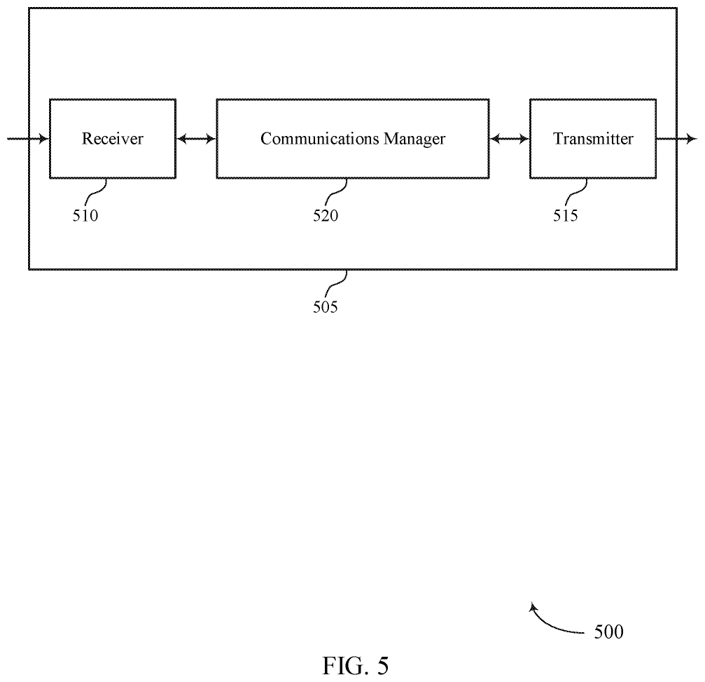

FIG. 5 shows a block diagram 500 of a device 505 that supports restricted UE assistance for MDT and QoE measurement alignment in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to restricted UE assistance for MDT and QoE measurement alignment). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to restricted UE assistance for MDT and QoE measurement alignment). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of restricted UE assistance for MDT and QoE measurement alignment as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for receiving a first control message including a QoE measurement configuration that indicates one or more QoE measurement references for the UE to perform and one or more indicator flags requesting a start indication and an end indication associated with a measurement session for the one or more QoE measurement references. The communications manager 520 may be configured as or otherwise support a means for transmitting the start indication associated with the measurement session for the one or more QoE measurement references based on an indicator flag of the one or more indicator flags being set for the measurement session. The communications manager 520 may be configured as or otherwise support a means for receiving, based on the start indication, a second control message including a MDT measurement configuration that indicates one or more MDT measurements for the UE to perform in addition to the one or more QoE measurement references. The communications manager 520 may be configured as or otherwise support a means for transmitting the end indication associated with the measurement session based on performing measurements for the one or more QoE measurement references and the one or more MDT measurements.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced processing, reduced power consumption, more efficient utilization of communication resources (e.g., reduced RRC resource use), more accurate power reporting, and a reduction in measurements performed at unnecessary times to increase power savings.

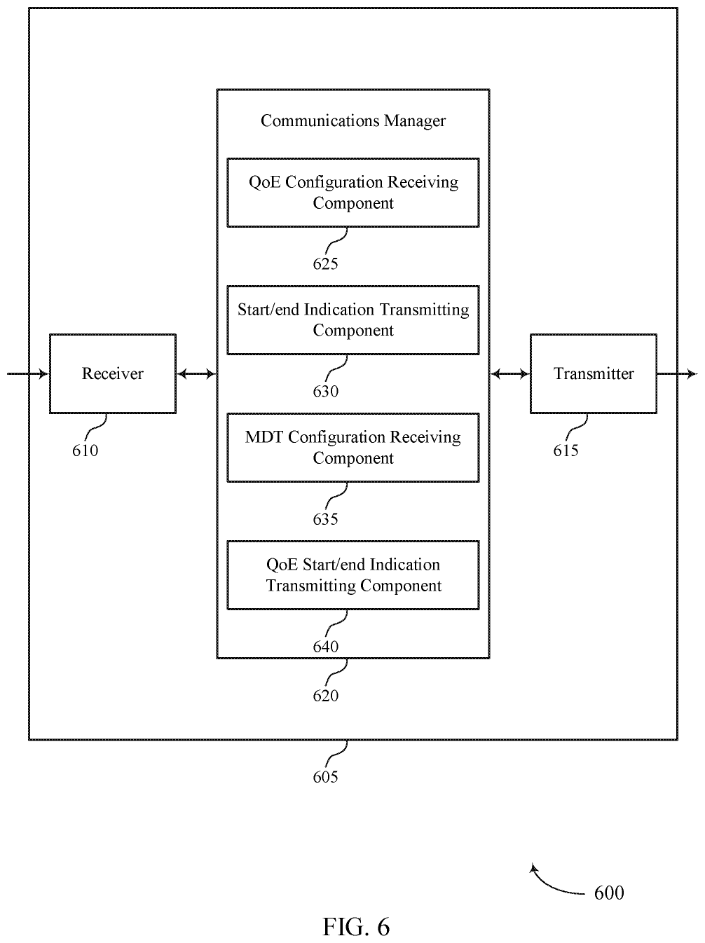

FIG. 6 shows a block diagram 600 of a device 605 that supports restricted UE assistance for MDT and QoE measurement alignment in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to restricted UE assistance for MDT and QoE measurement alignment). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to restricted UE assistance for MDT and QoE measurement alignment). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of restricted UE assistance for MDT and QoE measurement alignment as described herein. For example, the communications manager 620 may include a QoE configuration receiving component 625, a start/end indication transmitting component 630, an MDT configuration receiving component 635, a QoE start/end indication transmitting component 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The QoE configuration receiving component 625 may be configured as or otherwise support a means for receiving a first control message including a QoE measurement configuration that indicates one or more QoE measurement references for the UE to perform and one or more indicator flags requesting a start indication and an end indication associated with a measurement session for the one or more QoE measurement references. The start/end indication transmitting component 630 may be configured as or otherwise support a means for transmitting the start indication associated with the measurement session for the one or more QoE measurement references based on an indicator flag of the one or more indicator flags being set for the measurement session. The MDT configuration receiving component 635 may be configured as or otherwise support a means for receiving, based on the start indication, a second control message including a MDT measurement configuration that indicates one or more MDT measurements for the UE to perform in addition to the one or more QoE measurement references. The QoE start/end indication transmitting component 640 may be configured as or otherwise support a means for transmitting the end indication associated with the measurement session based on performing measurements for the one or more QoE measurement references and the one or more MDT measurements.

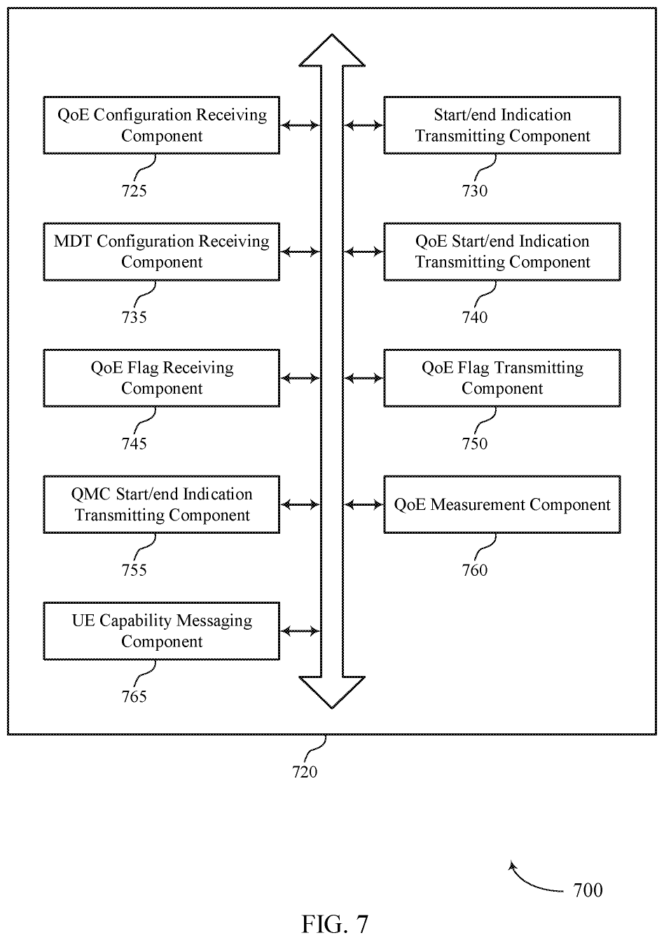

FIG. 7 shows a block diagram 700 of a communications manager 720 that supports restricted UE assistance for MDT and QoE measurement alignment in accordance with aspects of the present disclosure. The communications manager 720 may be an example of aspects of a communications manager 520, a communications manager 620, or both, as described herein. The communications manager 720, or various components thereof, may be an example of means for performing various aspects of restricted UE assistance for MDT and QoE measurement alignment as described herein. For example, the communications manager 720 may include a QoE configuration receiving component 725, a start/end indication transmitting component 730, an MDT configuration receiving component 735, a QoE start/end indication transmitting component 740, a QoE flag receiving component 745, a QoE flag transmitting component 750, an QMC start/end indication transmitting component 755, a QoE measurement component 760, a UE capability messaging component 765, or any combination thereof. Each of these components may communicate, directly or indirectly, with one another (e.g., via one or more buses).

The communications manager 720 may support wireless communication at a UE in accordance with examples as disclosed herein. The QoE configuration receiving component 725 may be configured as or otherwise support a means for receiving a first control message including a QoE measurement configuration that indicates one or more QoE measurement references for the UE to perform and one or more indicator flags requesting a start indication and an end indication associated with a measurement session for the one or more QoE measurement references. The start/end indication transmitting component 730 may be configured as or otherwise support a means for transmitting the start indication associated with the measurement session for the one or more QoE measurement references based on an indicator flag of the one or more indicator flags being set for the measurement session. The MDT configuration receiving component 735 may be configured as or otherwise support a means for receiving, based on the start indication, a second control message including a MDT measurement configuration that indicates one or more MDT measurements for the UE to perform in addition to the one or more QoE measurement references. The QoE start/end indication transmitting component 740 may be configured as or otherwise support a means for transmitting the end indication associated with the measurement session based on performing measurements for the one or more QoE measurement references and the one or more MDT measurements.

In some examples, the QoE flag receiving component 745 may be configured as or otherwise support a means for receiving a single indicator flag for a single QoE measurement reference. In some examples, the QoE start/end indication transmitting component 740 may be configured as or otherwise support a means for transmitting both the start indication and the end indication for the single QoE measurement reference in accordance with the single indicator flag.

In some examples, the QoE flag receiving component 745 may be configured as or otherwise support a means for receiving the one or more indicator flags for a subset of the one or more QoE measurement references, the subset of the one or more QoE measurement references being associated with the one or more MDT measurements. In some examples, the QoE start/end indication transmitting component 740 may be configured as or otherwise support a means for transmitting both the start indication and the end indication for the subset of the one or more QoE measurement references in accordance with the received one or more indicator flags.

In some examples, the QoE flag receiving component 745 may be configured as or otherwise support a means for receiving the one or more indicator flags for each of the one or more QoE measurement references. In some examples, the QoE start/end indication transmitting component 740 may be configured as or otherwise support a means for transmitting both the start indication and the end indication for each of the one or more QoE measurement references in accordance with the received one or more indicator flags.

In some examples, the QoE flag receiving component 745 may be configured as or otherwise support a means for receiving a first indicator flag applicable to each of the one or more QoE measurement references and an second indicator flag applicable to a single QoE measurement reference of the one or more QoE measurement references. In some examples, the QoE start/end indication transmitting component 740 may be configured as or otherwise support a means for transmitting both the start indication and the end indication for each of the one or more QoE measurement references in accordance with the first indicator flag.

In some examples, the QoE flag transmitting component 750 may be configured as or otherwise support a means for transmitting the one or more indicator flags from an access stratum layer of the UE to an application layer of the UE via an attention command including the QoE measurement configuration based on receiving the one or more indicator flags from a network entity.

In some examples, the QoE start/end indication transmitting component 740 may be configured as or otherwise support a means for transmitting both the start indication and the end indication from an application layer of the UE to an access stratum layer of the UE based on the received one or more indicator flags, where transmitting both the start indication and the end indication to a network entity is based on transmitting the start indication and the end indication from the application layer of the UE to the access stratum layer of the UE.

In some examples, the start indication includes a QoE measurement collection (QMC) start indication and the end indication includes a QMC end indication, and the QMC start/end indication transmitting component 755 may be configured as or otherwise support a means for transmitting the QMC start indication to indicate a set of QoE measurement references that are associated with the one or more MDT measurements. In some examples, the start indication includes a QoE measurement collection (QMC) start indication and the end indication includes a QMC end indication, and the QoE measurement component 760 may be configured as or otherwise support a means for performing the one or more the one or more QoE measurement references and the associated one or more MDT measurements in accordance with the QMC start indication. In some examples, the start indication includes a QoE measurement collection (QMC) start indication and the end indication includes a QMC end indication, and the QMC start/end indication transmitting component 755 may be configured as or otherwise support a means for transmitting the QMC end indication based on the performing.

In some examples, the MDT configuration receiving component 735 may be configured as or otherwise support a means for receiving an indication that the set of QoE measurement references are associated with the one or more MDT measurements.

In some examples, the indication includes a MDT alignment message, a trace reference indication associated with the one or more MDT measurements, or both.

In some examples, the QMC start/end indication transmitting component 755 may be configured as or otherwise support a means for transmitting the QMC start indication at a start of a first QoE measurement of the set. In some examples, the QoE measurement component 760 may be configured as or otherwise support a means for performing the one or more the one or more QoE measurement references and the one or more MDT measurements in accordance with the association. In some examples, the QMC start/end indication transmitting component 755 may be configured as or otherwise support a means for transmitting the QMC end indication at a last QoE measurement of the set based on the association between the one or more QoE measurement references and the one or more MDT measurements.

In some examples, the UE capability messaging component 765 may be configured as or otherwise support a means for transmitting a UE capability message that indicates a capability of the UE to transmit the start indication, the end indication, or both.

In some examples, the first control message includes a first RRC message.

In some examples, the QoE start/end indication transmitting component 740 may be configured as or otherwise support a means for transmitting the start indication and the end indication via a UE application layer measurement report RRC message. In some examples, the second control message includes a RRC reconfiguration message.

In some examples, the indicator flag includes a binary indicator. In some examples, a value of the binary indicator associates the one or more QoE measurement references with the one or more MDT measurements.

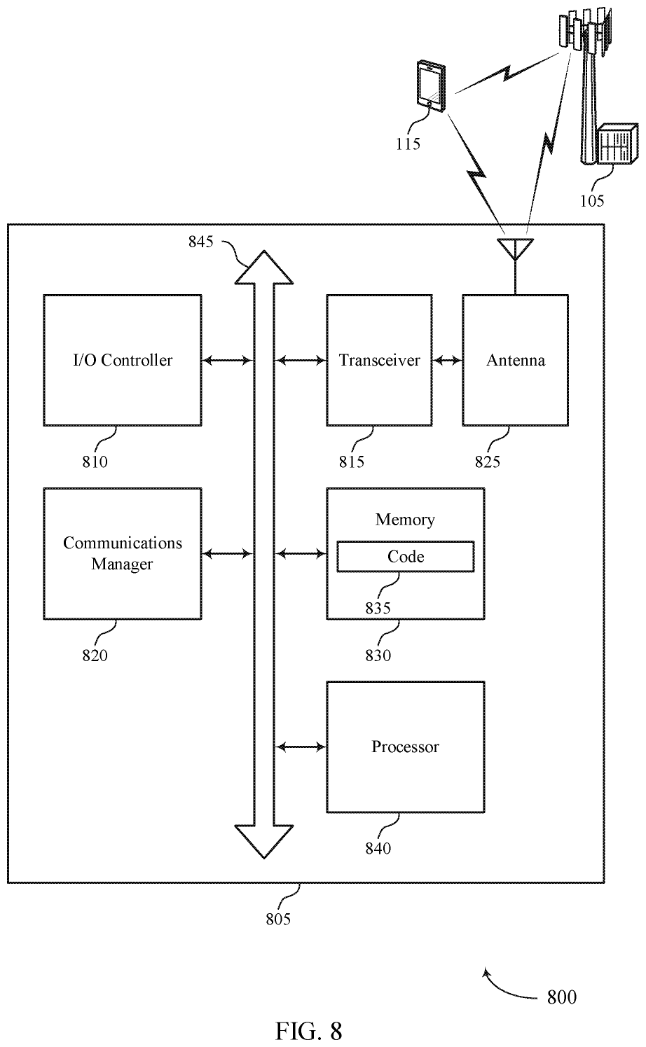

FIG. 8 shows a diagram of a system 800 including a device 805 that supports restricted UE assistance for MDT and QoE measurement alignment in accordance with aspects of the present disclosure. The device 805 may be an example of or include the components of a device 505, a device 605, or a UE 115 as described herein. The device 805 may communicate wirelessly with one or more network entities 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting restricted UE assistance for MDT and QoE measurement alignment). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving a first control message including a QoE measurement configuration that indicates one or more QoE measurement references for the UE to perform and one or more indicator flags requesting a start indication and an end indication associated with a measurement session for the one or more QoE measurement references. The communications manager 820 may be configured as or otherwise support a means for transmitting the start indication associated with the measurement session for the one or more QoE measurement references based on an indicator flag of the one or more indicator flags being set for the measurement session. The communications manager 820 may be configured as or otherwise support a means for receiving, based on the start indication, a second control message including a MDT measurement configuration that indicates one or more MDT measurements for the UE to perform in addition to the one or more QoE measurement references. The communications manager 820 may be configured as or otherwise support a means for transmitting the end indication associated with the measurement session based on performing measurements for the one or more QoE measurement references and the one or more MDT measurements.

By including or configuring the communications manager 820 in accordance with examples as described herein, the device 805 may support techniques for improved communication reliability, improved user experience related to reduced processing and post-processing, reduced power consumption due to fewer measurements being performed at unnecessary times, more efficient utilization of communication resources, improved coordination between devices, longer battery life, improved utilization of processing capability, and increased alignment between signaling quality measurements.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of restricted UE assistance for MDT and QoE measurement alignment as described herein, or the processor 840 and the memory 830 may be otherwise configured to perform or support such operations.

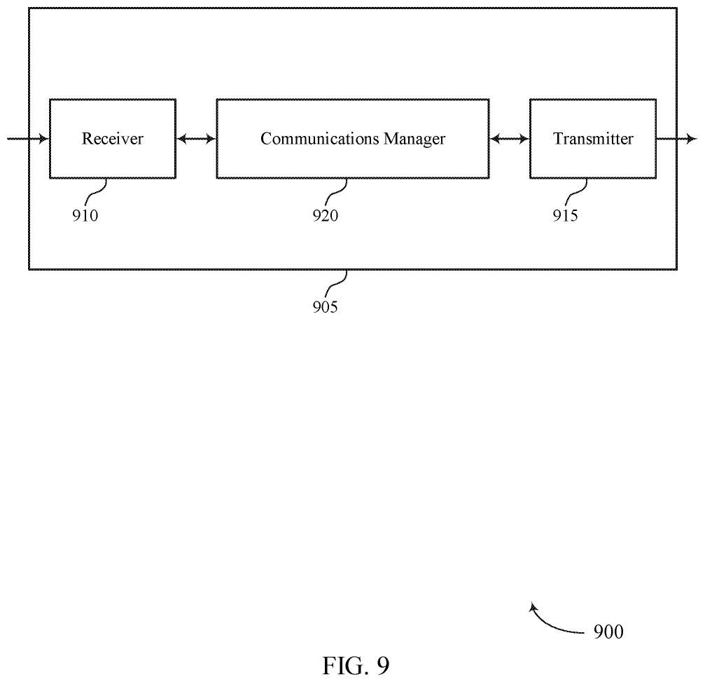

FIG. 9 shows a block diagram 900 of a device 905 that supports restricted UE assistance for MDT and QoE measurement alignment in accordance with aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to restricted UE assistance for MDT and QoE measurement alignment). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to restricted UE assistance for MDT and QoE measurement alignment). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of restricted UE assistance for MDT and QoE measurement alignment as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a network entity in accordance with examples as disclosed herein. For example, the communications manager 920 may be configured as or otherwise support a means for transmitting a first control message including a QoE measurement configuration that indicates one or more QoE measurement references for a UE to perform and one or more indicator flags requesting a start indication and an end indication associated with a measurement session for the one or more QoE measurement references. The communications manager 920 may be configured as or otherwise support a means for receiving the start indication associated with the measurement session for the one or more QoE measurement references based on an indicator flag of the one or more indicator flags being set for the measurement session. The communications manager 920 may be configured as or otherwise support a means for transmitting, based on the start indication, a second control message including a MDT measurement configuration that indicates one or more MDT measurements for the UE to perform in addition to the one or more QoE measurement references. The communications manager 920 may be configured as or otherwise support a means for receiving the end indication associated with the measurement session and a measurement report including the one or more QoE measurement references and the one or more MDT measurements.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for reduced processing, reduced power consumption, more efficient utilization of communication resources, and reduced unnecessary usage of radio resources.

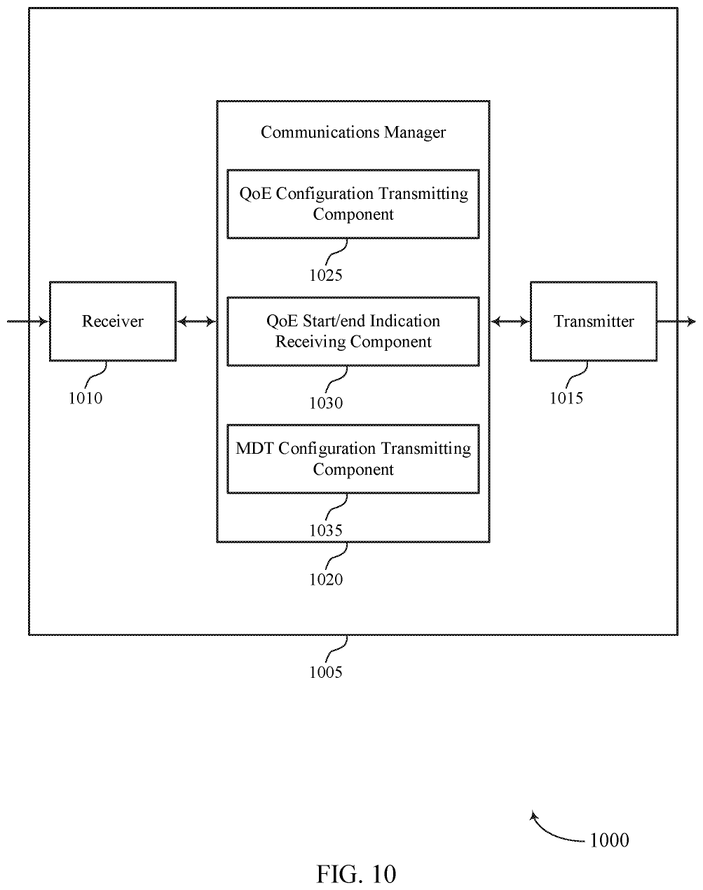

FIG. 10 shows a block diagram 1000 of a device 1005 that supports restricted UE assistance for MDT and QoE measurement alignment in accordance with aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to restricted UE assistance for MDT and QoE measurement alignment). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to restricted UE assistance for MDT and QoE measurement alignment). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of restricted UE assistance for MDT and QoE measurement alignment as described herein. For example, the communications manager 1020 may include a QoE configuration transmitting component 1025, a QoE start/end indication receiving component 1030, an MDT configuration transmitting component 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a network entity in accordance with examples as disclosed herein. The QoE configuration transmitting component 1025 may be configured as or otherwise support a means for transmitting a first control message including a QoE measurement configuration that indicates one or more QoE measurement references for a UE to perform and one or more indicator flags requesting a start indication and an end indication associated with a measurement session for the one or more QoE measurement references. The QoE start/end indication receiving component 1030 may be configured as or otherwise support a means for receiving the start indication associated with the measurement session for the one or more QoE measurement references based on an indicator flag of the one or more indicator flags being set for the measurement session. The MDT configuration transmitting component 1035 may be configured as or otherwise support a means for transmitting, based on the start indication, a second control message including a MDT measurement configuration that indicates one or more MDT measurements for the UE to perform in addition to the one or more QoE measurement references. The QoE start/end indication receiving component 1030 may be configured as or otherwise support a means for receiving the end indication associated with the measurement session and a measurement report including the one or more QoE measurement references and the one or more MDT measurements.

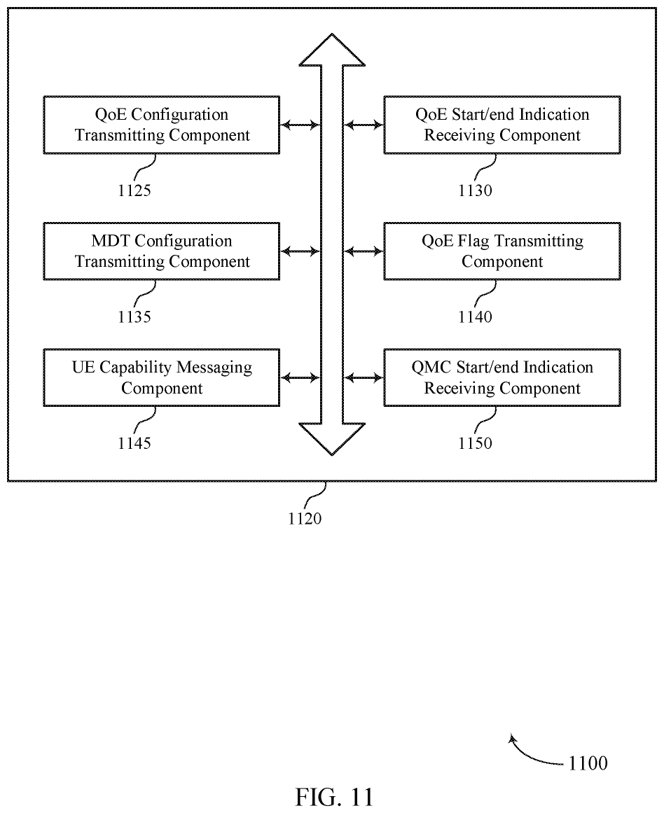

FIG. 11 shows a block diagram 1100 of a communications manager 1120 that supports restricted UE assistance for MDT and QoE measurement alignment in accordance with aspects of the present disclosure. The communications manager 1120 may be an example of aspects of a communications manager 920, a communications manager 1020, or both, as described herein. The communications manager 1120, or various components thereof, may be an example of means for performing various aspects of restricted UE assistance for MDT and QoE measurement alignment as described herein. For example, the communications manager 1120 may include a QoE configuration transmitting component 1125, a QoE start/end indication receiving component 1130, an MDT configuration transmitting component 1135, a QoE flag transmitting component 1140, a UE capability messaging component 1145, an QMC start/end indication receiving component 1150, or any combination thereof. Each of these components may communicate, directly or indirectly, with one another (e.g., via one or more buses).

The communications manager 1120 may support wireless communication at a network entity in accordance with examples as disclosed herein. The QoE configuration transmitting component 1125 may be configured as or otherwise support a means for transmitting a first control message including a QoE measurement configuration that indicates one or more QoE measurement references for a UE to perform and one or more indicator flags requesting a start indication and an end indication associated with a measurement session for the one or more QoE measurement references. The QoE start/end indication receiving component 1130 may be configured as or otherwise support a means for receiving the start indication associated with the measurement session for the one or more QoE measurement references based on an indicator flag of the one or more indicator flags being set for the measurement session. The MDT configuration transmitting component 1135 may be configured as or otherwise support a means for transmitting, based on the start indication, a second control message including a MDT measurement configuration that indicates one or more MDT measurements for the UE to perform in addition to the one or more QoE measurement references. In some examples, the QoE start/end indication receiving component 1130 may be configured as or otherwise support a means for receiving the end indication associated with the measurement session and a measurement report including the one or more QoE measurement references and the one or more MDT measurements.

In some examples, the QoE flag transmitting component 1140 may be configured as or otherwise support a means for transmitting a single indicator flag for a single QoE measurement reference. In some examples, the QoE start/end indication receiving component 1130 may be configured as or otherwise support a means for receiving both the start indication and the end indication for the single QoE measurement reference in accordance with the single indicator flag.

In some examples, the QoE flag transmitting component 1140 may be configured as or otherwise support a means for transmitting the one or more indicator flags indicating a subset of the one or more QoE measurement references being associated with the one or more MDT measurements. In some examples, the QoE start/end indication receiving component 1130 may be configured as or otherwise support a means for receiving both the start indication and the end indication for the subset of the one or more QoE measurement references in accordance with the received one or more indicator flags.

In some examples, the QoE flag transmitting component 1140 may be configured as or otherwise support a means for transmitting the one or more indicator flags for each of the one or more QoE measurement references. In some examples, the QoE start/end indication receiving component 1130 may be configured as or otherwise support a means for receiving both the start indication and the end indication for each of the one or more QoE measurement references in accordance with the received one or more indicator flags.

In some examples, the QoE flag transmitting component 1140 may be configured as or otherwise support a means for transmitting a first indicator flag applicable to each of the one or more QoE measurement references and an second indicator flag applicable to a single QoE measurement reference of the one or more QoE measurement references. In some examples, the QoE start/end indication receiving component 1130 may be configured as or otherwise support a means for receiving both the start indication and the end indication for each of the one or more QoE measurement references in accordance with the first indicator flag.

In some examples, the start indication includes a QoE measurement collection (QMC) start indication and the end indication includes a QMC end indication, and the QoE start/end indication receiving component 1130 may be configured as or otherwise support a means for receiving the QMC start indication that indicates an association between a set of QoE measurement references and the one or more MDT measurements. In some examples, the start indication includes a QoE measurement collection (QMC) start indication and the end indication includes a QMC end indication, and the QoE start/end indication receiving component 1130 may be configured as or otherwise support a means for receiving the QMC end indication and the measurement report based on the association.

In some examples, the QoE configuration transmitting component 1125 may be configured as or otherwise support a means for transmitting an indication that the set of QoE measurement references are associated with the one or more MDT measurements.

In some examples, the indication includes a MDT alignment message, a trace reference indication associated with the one or more MDT measurements, or both.

In some examples, the QMC start/end indication receiving component 1150 may be configured as or otherwise support a means for receiving the QMC start indication at a start of a first QoE measurement of the set. In some examples, the QMC start/end indication receiving component 1150 may be configured as or otherwise support a means for receiving the QMC end indication at a last QoE measurement of the set based on the association between the one or more QoE measurement references and the one or more MDT measurements.

In some examples, the UE capability messaging component 1145 may be configured as or otherwise support a means for receiving a UE capability message that indicates a capability of the UE to transmit the start indication, the end indication, or both.

In some examples, the first control message includes a first RRC message.

In some examples, the QoE start/end indication receiving component 1130 may be configured as or otherwise support a means for receiving the start indication and the end indication via a UE application layer measurement report RRC message.

In some examples, the second control message includes a RRC reconfiguration message.

In some examples, the indicator flag includes a binary indicator. In some examples, a value of the binary indicator associates the one or more QoE measurement references with the one or more MDT measurements.

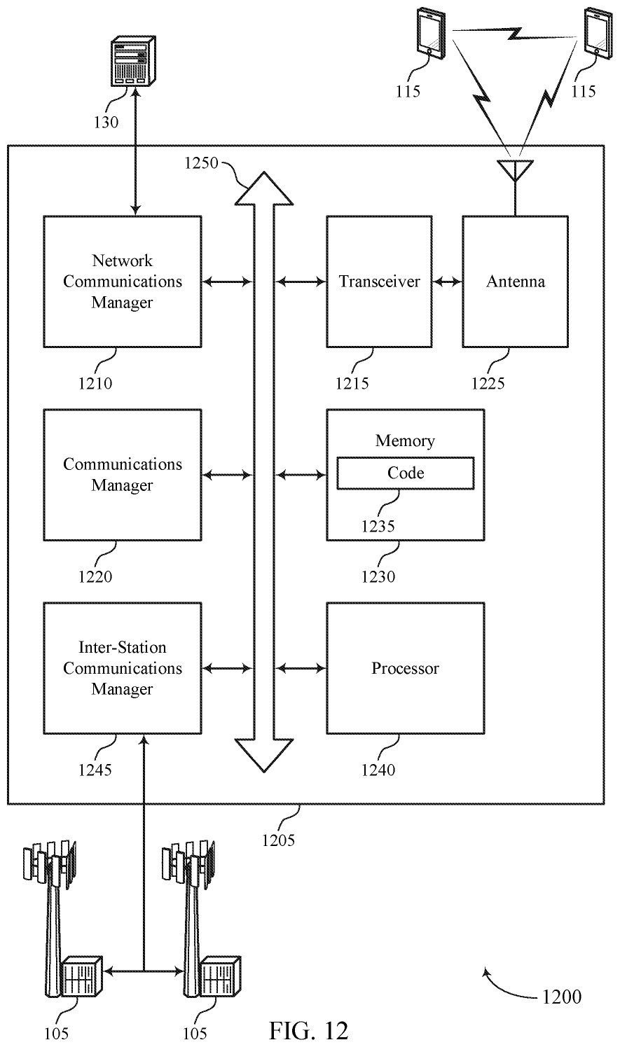

FIG. 12 shows a diagram of a system 1200 including a device 1205 that supports restricted UE assistance for MDT and QoE measurement alignment in accordance with aspects of the present disclosure. The device 1205 may be an example of or include the components of a device 905, a device 1005, or a network entity 105 as described herein. The device 1205 may communicate wirelessly with one or more network entities 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting restricted UE assistance for MDT and QoE measurement alignment). For example, the device 1205 or a component of the device 1205 may include a processor 1240 and memory 1230 coupled with or to the processor 1240, the processor 1240 and memory 1230 configured to perform various functions described herein.

The inter-station communications manager 1245 may manage communications with other network entities 105, and may include a controller or scheduler for controlling communications with UEs 115 in cooperation with other network entities 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting a first control message including a QoE measurement configuration that indicates one or more QoE measurement references for a UE to perform and one or more indicator flags requesting a start indication and an end indication associated with a measurement session for the one or more QoE measurement references. The communications manager 1220 may be configured as or otherwise support a means for receiving the start indication associated with the measurement session for the one or more QoE measurement references based on an indicator flag of the one or more indicator flags being set for the measurement session. The communications manager 1220 may be configured as or otherwise support a means for transmitting, based on the start indication, a second control message including a MDT measurement configuration that indicates one or more MDT measurements for the UE to perform in addition to the one or more QoE measurement references. The communications manager 1220 may be configured as or otherwise support a means for receiving the end indication associated with the measurement session and a measurement report including the one or more QoE measurement references and the one or more MDT measurements.

By including or configuring the communications manager 1220 in accordance with examples as described herein, the device 1205 may support techniques for improved communication reliability, improved user experience related to reduced processing and post-processing, reduced power consumption due to fewer measurements being performed at unnecessary times, more efficient utilization of communication resources, improved coordination between devices, longer battery life, improved utilization of processing capability, and increased alignment between signaling quality measurements.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of restricted UE assistance for MDT and QoE measurement alignment as described herein, or the processor 1240 and the memory 1230 may be otherwise configured to perform or support such operations.

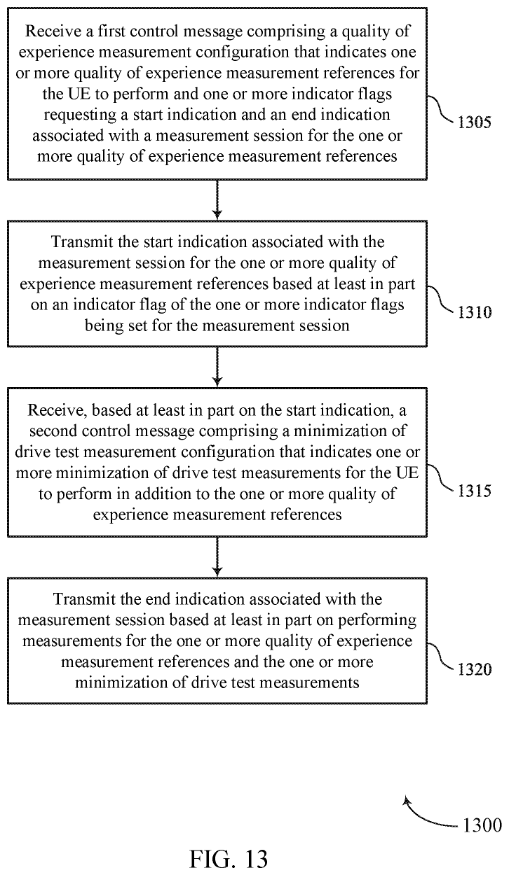

FIG. 13 shows a flowchart illustrating a method 1300 that supports restricted UE assistance for MDT and QoE measurement alignment in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving a first control message including a QoE measurement configuration that indicates one or more QoE measurement references for the UE to perform and one or more indicator flags requesting a start indication and an end indication associated with a measurement session for the one or more QoE measurement references. The operations of 1305 may be performed in accordance with examples as disclosed herein. In some examples, aspects of the operations of 1305 may be performed by a QoE configuration receiving component 725 as described with reference to FIG. 7.

At 1310, the method may include transmitting the start indication associated with the measurement session for the one or more QoE measurement references based on an indicator flag of the one or more indicator flags being set for the measurement session. The operations of 1310 may be performed in accordance with examples as disclosed herein. In some examples, aspects of the operations of 1310 may be performed by a start/end indication transmitting component 730 as described with reference to FIG. 7.

At 1315, the method may include receiving, based on the start indication, a second control message including a MDT measurement configuration that indicates one or more MDT measurements for the UE to perform in addition to the one or more QoE measurement references. The operations of 1315 may be performed in accordance with examples as disclosed herein. In some examples, aspects of the operations of 1315 may be performed by an MDT configuration receiving component 735 as described with reference to FIG. 7.

At 1320, the method may include transmitting the end indication associated with the measurement session based on performing measurements for the one or more QoE measurement references and the one or more MDT measurements. The operations of 1320 may be performed in accordance with examples as disclosed herein. In some examples, aspects of the operations of 1320 may be performed by a QoE start/end indication transmitting component 740 as described with reference to FIG. 7.

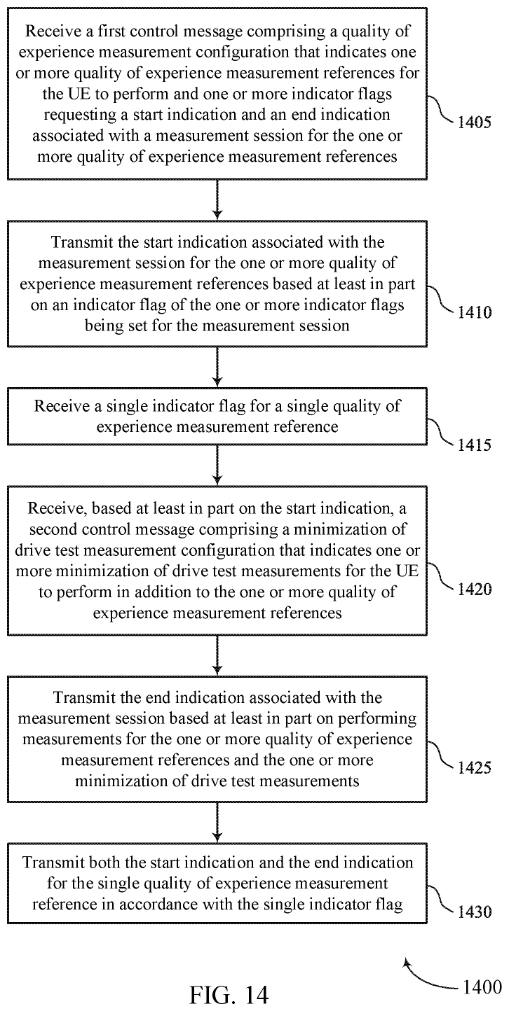

FIG. 14 shows a flowchart illustrating a method 1400 that supports restricted UE assistance for MDT and QoE measurement alignment in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving a first control message including a QoE measurement configuration that indicates one or more QoE measurement references for the UE to perform and one or more indicator flags requesting a start indication and an end indication associated with a measurement session for the one or more QoE measurement references. The operations of 1405 may be performed in accordance with examples as disclosed herein. In some examples, aspects of the operations of 1405 may be performed by a QoE configuration receiving component 725 as described with reference to FIG. 7.

At 1410, the method may include transmitting the start indication associated with the measurement session for the one or more QoE measurement references based on an indicator flag of the one or more indicator flags being set for the measurement session. The operations of 1410 may be performed in accordance with examples as disclosed herein. In some examples, aspects of the operations of 1410 may be performed by a start/end indication transmitting component 730 as described with reference to FIG. 7.

At 1415, the method may include receiving a single indicator flag for a single QoE measurement reference. The operations of 1415 may be performed in accordance with examples as disclosed herein. In some examples, aspects of the operations of 1415 may be performed by a QoE flag receiving component 745 as described with reference to FIG. 7.

At 1420, the method may include receiving, based on the start indication, a second control message including a MDT measurement configuration that indicates one or more MDT measurements for the UE to perform in addition to the one or more QoE measurement references. The operations of 1420 may be performed in accordance with examples as disclosed herein. In some examples, aspects of the operations of 1420 may be performed by an MDT configuration receiving component 735 as described with reference to FIG. 7.

At 1425, the method may include transmitting the end indication associated with the measurement session based on performing measurements for the one or more QoE measurement references and the one or more MDT measurements. The operations of 1425 may be performed in accordance with examples as disclosed herein. In some examples, aspects of the operations of 1425 may be performed by a QoE start/end indication transmitting component 740 as described with reference to FIG. 7.

At 1430, the method may include transmitting both the start indication and the end indication for the single QoE measurement reference in accordance with the single indicator flag. The operations of 1430 may be performed in accordance with examples as disclosed herein. In some examples, aspects of the operations of 1430 may be performed by a QoE start/end indication transmitting component 740 as described with reference to FIG. 7.

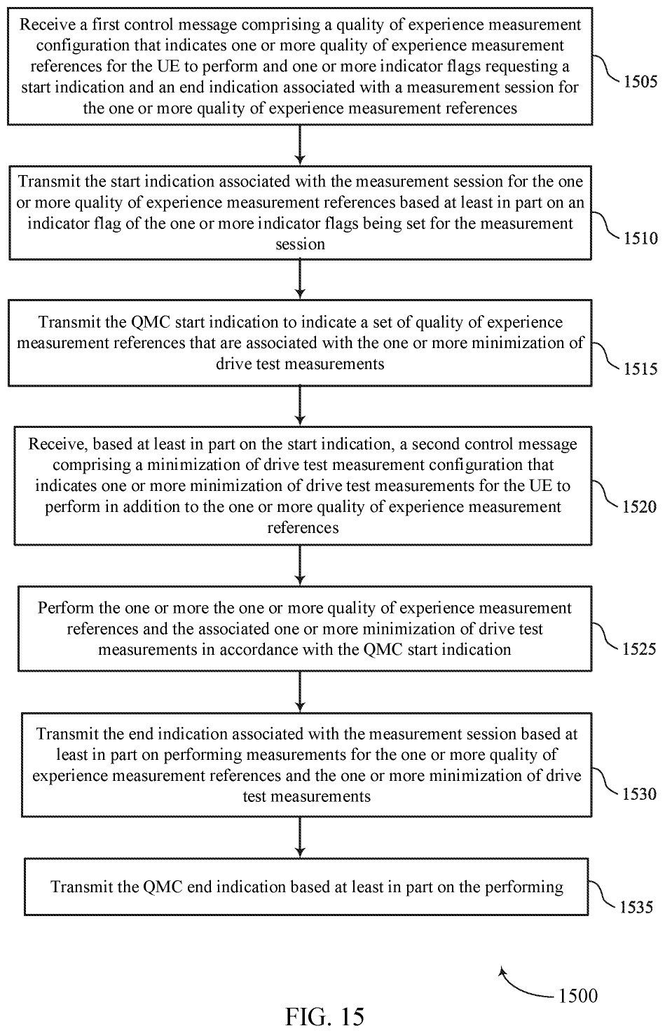

FIG. 15 shows a flowchart illustrating a method 1500 that supports restricted UE assistance for MDT and QoE measurement alignment in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include receiving a first control message including a QoE measurement configuration that indicates one or more QoE measurement references for the UE to perform and one or more indicator flags requesting a start indication and an end indication associated with a measurement session for the one or more QoE measurement references. The operations of 1505 may be performed in accordance with examples as disclosed herein. In some examples, aspects of the operations of 1505 may be performed by a QoE configuration receiving component 725 as described with reference to FIG. 7.

At 1510, the method may include transmitting the start indication associated with the measurement session for the one or more QoE measurement references based on an indicator flag of the one or more indicator flags being set for the measurement session. The operations of 1510 may be performed in accordance with examples as disclosed herein. In some examples, aspects of the operations of 1510 may be performed by a start/end indication transmitting component 730 as described with reference to FIG. 7.

At 1515, the method may include transmitting the QMC start indication to indicate a set of QoE measurement references that are associated with the one or more MDT measurements. The operations of 1515 may be performed in accordance with examples as disclosed herein. In some examples, aspects of the operations of 1515 may be performed by an QMC start/end indication transmitting component 755 as described with reference to FIG. 7.

At 1520, the method may include receiving, based on the start indication, a second control message including a MDT measurement configuration that indicates one or more MDT measurements for the UE to perform in addition to the one or more QoE measurement references. The operations of 1520 may be performed in accordance with examples as disclosed herein. In some examples, aspects of the operations of 1520 may be performed by an MDT configuration receiving component 735 as described with reference to FIG. 7.

At 1525, the method may include performing the one or more the one or more QoE measurement references and the associated one or more MDT measurements in accordance with the QMC start indication. The operations of 1525 may be performed in accordance with examples as disclosed herein. In some examples, aspects of the operations of 1525 may be performed by a QoE measurement component 760 as described with reference to FIG. 7.

At 1530, the method may include transmitting the end indication associated with the measurement session based on performing measurements for the one or more QoE measurement references and the one or more MDT measurements. The operations of 1530 may be performed in accordance with examples as disclosed herein. In some examples, aspects of the operations of 1530 may be performed by a QoE start/end indication transmitting component 740 as described with reference to FIG. 7.

At 1535, the method may include transmitting the QMC end indication based on the performing. The operations of 1535 may be performed in accordance with examples as disclosed herein. In some examples, aspects of the operations of 1535 may be performed by an QMC start/end indication transmitting component 755 as described with reference to FIG. 7.

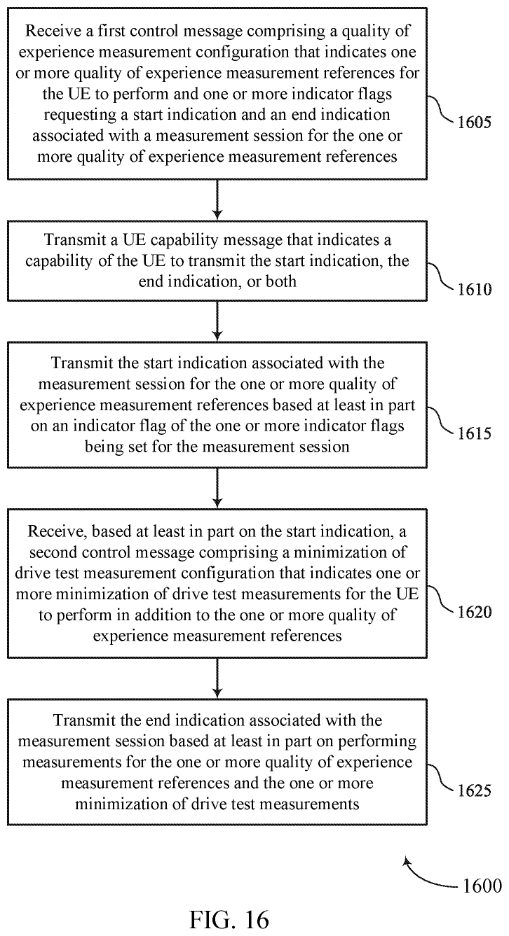

FIG. 16 shows a flowchart illustrating a method 1600 that supports restricted UE assistance for MDT and QoE measurement alignment in accordance with aspects of the present disclosure. The operations of the method 1600 may be implemented by a UE or its components as described herein. For example, the operations of the method 1600 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1605, the method may include receiving a first control message including a QoE measurement configuration that indicates one or more QoE measurement references for the UE to perform and one or more indicator flags requesting a start indication and an end indication associated with a measurement session for the one or more QoE measurement references. The operations of 1605 may be performed in accordance with examples as disclosed herein. In some examples, aspects of the operations of 1605 may be performed by a QoE configuration receiving component 725 as described with reference to FIG. 7.

At 1610, the method may include transmitting a UE capability message that indicates a capability of the UE to transmit the start indication, the end indication, or both. The operations of 1610 may be performed in accordance with examples as disclosed herein. In some examples, aspects of the operations of 1610 may be performed by a UE capability messaging component 765 as described with reference to FIG. 7.

At 1615, the method may include transmitting the start indication associated with the measurement session for the one or more QoE measurement references based on an indicator flag of the one or more indicator flags being set for the measurement session. The operations of 1615 may be performed in accordance with examples as disclosed herein. In some examples, aspects of the operations of 1615 may be performed by a start/end indication transmitting component 730 as described with reference to FIG. 7.

At 1620, the method may include receiving, based on the start indication, a second control message including a MDT measurement configuration that indicates one or more MDT measurements for the UE to perform in addition to the one or more QoE measurement references. The operations of 1620 may be performed in accordance with examples as disclosed herein. In some examples, aspects of the operations of 1620 may be performed by an MDT configuration receiving component 735 as described with reference to FIG. 7.

At 1625, the method may include transmitting the end indication associated with the measurement session based on performing measurements for the one or more QoE measurement references and the one or more MDT measurements. The operations of 1625 may be performed in accordance with examples as disclosed herein. In some examples, aspects of the operations of 1625 may be performed by a QoE start/end indication transmitting component 740 as described with reference to FIG. 7.

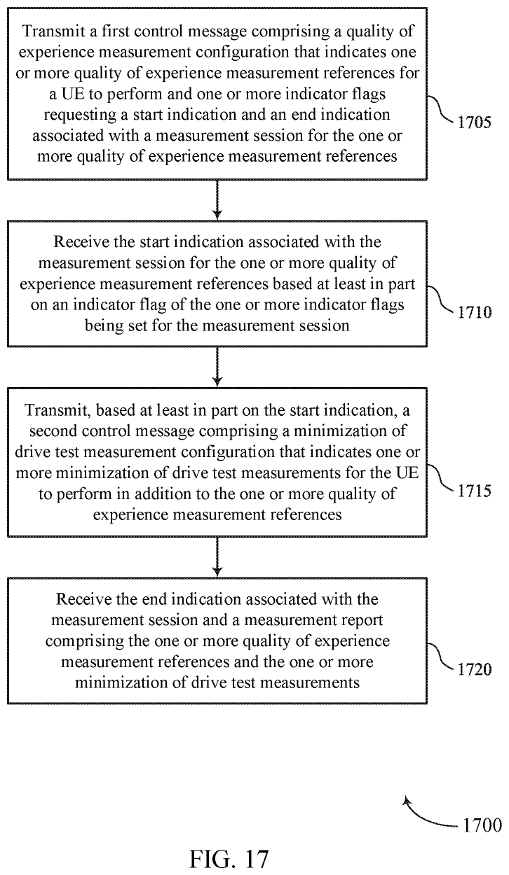

FIG. 17 shows a flowchart illustrating a method 1700 that supports restricted UE assistance for MDT and QoE measurement alignment in accordance with aspects of the present disclosure. The operations of the method 1700 may be implemented by a network entity or its components as described herein. For example, the operations of the method 1700 may be performed by a network entity 105 as described with reference to FIGS. 1 through 4 and 9 through 12. In some examples, a network entity may execute a set of instructions to control the functional elements of the network entity to perform the described functions. Additionally or alternatively, the network entity may perform aspects of the described functions using special-purpose hardware.

At 1705, the method may include transmitting a first control message including a QoE measurement configuration that indicates one or more QoE measurement references for a UE to perform and one or more indicator flags requesting a start indication and an end indication associated with a measurement session for the one or more QoE measurement references. The operations of 1705 may be performed in accordance with examples as disclosed herein. In some examples, aspects of the operations of 1705 may be performed by a QoE configuration transmitting component 1125 as described with reference to FIG. 11.

At 1710, the method may include receiving the start indication associated with the measurement session for the one or more QoE measurement references based on an indicator flag of the one or more indicator flags being set for the measurement session. The operations of 1710 may be performed in accordance with examples as disclosed herein. In some examples, aspects of the operations of 1710 may be performed by a QoE start/end indication receiving component 1130 as described with reference to FIG. 11.

At 1715, the method may include transmitting, based on the start indication, a second control message including a MDT measurement configuration that indicates one or more MDT measurements for the UE to perform in addition to the one or more QoE measurement references. The operations of 1715 may be performed in accordance with examples as disclosed herein. In some examples, aspects of the operations of 1715 may be performed by an MDT configuration transmitting component 1135 as described with reference to FIG. 11.

At 1720, the method may include receiving the end indication associated with the measurement session and a measurement report including the one or more QoE measurement references and the one or more MDT measurements. The operations of 1720 may be performed in accordance with examples as disclosed herein. In some examples, aspects of the operations of 1720 may be performed by a QoE start/end indication receiving component 1130 as described with reference to FIG. 11.

The following provides an overview of aspects of the present disclosure:

Aspect 1: A method for wireless communication at a UE, comprising: receiving a first control message comprising a QoE measurement configuration that indicates one or more QoE measurement references for the UE to perform and one or more indicator flags requesting a start indication and an end indication associated with a measurement session for the one or more QoE measurement references: transmitting the start indication associated with the measurement session for the one or more QoE measurement references based at least in part on an indicator flag of the one or more indicator flags being set for the measurement session: receiving, based at least in part on the start indication, a second control message comprising a MDT measurement configuration that indicates one or more MDT measurements for the UE to perform in addition to the one or more QoE measurement references; and transmitting the end indication associated with the measurement session based at least in part on performing measurements for the one or more QoE measurement references and the one or more MDT measurements.

Aspect 2: The method of aspect 1, further comprising: receiving a single indicator flag for a single QoE measurement reference; and transmitting both the start indication and the end indication for the single QoE measurement reference in accordance with the single indicator flag.

Aspect 3: The method of any of aspects 1 through 2, further comprising: receiving the one or more indicator flags for a subset of the one or more QoE measurement references, the subset of the one or more QoE measurement references being associated with the one or more MDT measurements; and transmitting both the start indication and the end indication for the subset of the one or more QoE measurement references in accordance with the received one or more indicator flags.

Aspect 4: The method of any of aspects 1 through 3, further comprising: receiving the one or more indicator flags for each of the one or more QoE measurement references; and transmitting both the start indication and the end indication for each of the one or more QoE measurement references in accordance with the received one or more indicator flags.

Aspect 5: The method of any of aspects 1 through 4, further comprising: receiving a first indicator flag applicable to each of the one or more QoE measurement references and an second indicator flag applicable to a single QoE measurement reference of the one or more QoE measurement references; and transmitting both the start indication and the end indication for each of the one or more QoE measurement references in accordance with the first indicator flag.

Aspect 6: The method of any of aspects 1 through 5, further comprising: transmitting the one or more indicator flags from an access stratum layer of the UE to an application layer of the UE via an attention command comprising the QoE measurement configuration based at least in part on receiving the one or more indicator flags from a network entity.

Aspect 7: The method of any of aspects 1 through 6, further comprising: transmitting both the start indication and the end indication from an application layer of the UE to an access stratum layer of the UE based at least in part on the received one or more indicator flags, wherein transmitting both the start indication and the end indication to a network entity is based at least in part on transmitting the start indication and the end indication from the application layer of the UE to the access stratum layer of the UE.

Aspect 8: The method of any of aspects 1 through 7, wherein the start indication comprises a QoE measurement collection (QMC) start indication and the end indication comprises a QMC end indication, the method further comprising: transmitting the QMC start indication to indicate a set of QoE measurement references that are associated with the one or more MDT measurements: performing the one or more the one or more QoE measurement references and the associated one or more MDT measurements in accordance with the QMC start indication; and transmitting the QMC end indication based at least in part on the performing.

Aspect 9: The method of aspect 8, further comprising: receiving an indication that the set of QoE measurement references are associated with the one or more MDT measurements.

Aspect 10: The method of aspect 9, wherein the indication comprises a MDT alignment message, a trace reference indication associated with the one or more MDT measurements, or both.

Aspect 11: The method of any of aspects 8 through 10, further comprising: transmitting the QMC start indication at a start of a first QoE measurement of the set; performing the one or more the one or more QoE measurement references and the one or more MDT measurements in accordance with the association; and transmitting the QMC end indication at a last QoE measurement of the set based at least in part on the association between the one or more QoE measurement references and the one or more MDT measurements.

Aspect 12: The method of any of aspects 1 through 11, further comprising: transmitting a UE capability message that indicates a capability of the UE to transmit the start indication, the end indication, or both.

Aspect 13: The method of any of aspects 1 through 12, wherein the first control message comprises a first RRC message.

Aspect 14: The method of any of aspects 1 through 13, further comprising: transmitting the start indication and the end indication via a UE application layer measurement report RRC message.

Aspect 15: The method of any of aspects 1 through 14, wherein the second control message comprises a RRC reconfiguration message.

Aspect 16: The method of any of aspects 1 through 15, wherein the indicator flag comprises a binary indicator, a value of the binary indicator associates the one or more QoE measurement references with the one or more MDT measurements.

Aspect 17: A method for wireless communication at a network entity, comprising: transmitting a first control message comprising a QoE measurement configuration that indicates one or more QoE measurement references for a UE to perform and one or more indicator flags requesting a start indication and an end indication associated with a measurement session for the one or more QoE measurement references: receiving the start indication associated with the measurement session for the one or more QoE measurement references based at least in part on an indicator flag of the one or more indicator flags being set for the measurement session: transmitting, based at least in part on the start indication, a second control message comprising a MDT measurement configuration that indicates one or more MDT measurements for the UE to perform in addition to the one or more QoE measurement references; and receiving the end indication associated with the measurement session and a measurement report comprising the one or more QoE measurement references and the one or more MDT measurements.

Aspect 18: The method of aspect 17, further comprising: transmitting a single indicator flag for a single QoE measurement reference; and receiving both the start indication and the end indication for the single QoE measurement reference in accordance with the single indicator flag.

Aspect 19: The method of any of aspects 17 through 18, further comprising: transmitting the one or more indicator flags indicating a subset of the one or more QoE measurement references being associated with the one or more MDT measurements; and receiving both the start indication and the end indication for the subset of the one or more QoE measurement references in accordance with the received one or more indicator flags.

Aspect 20: The method of any of aspects 17 through 19, further comprising: transmitting the one or more indicator flags for each of the one or more QoE measurement references; and receiving both the start indication and the end indication for each of the one or more QoE measurement references in accordance with the received one or more indicator flags.

Aspect 21: The method of any of aspects 17 through 20, further comprising: transmitting a first indicator flag applicable to each of the one or more QoE measurement references and an second indicator flag applicable to a single QoE measurement reference of the one or more QoE measurement references; and receiving both the start indication and the end indication for each of the one or more QoE measurement references in accordance with the first indicator flag.

Aspect 22: The method of any of aspects 17 through 21, wherein the start indication comprises a QMC start indication and the end indication comprises a QMC end indication, the method further comprising: receiving the QMC start indication that indicates an association between a set of QoE measurement references and the one or more MDT measurements: receiving the QMC end indication and the measurement report based at least in part on the association.

Aspect 23: The method of aspect 22, further comprising: transmitting an indication that the set of QoE measurement references are associated with the one or more MDT measurements.

Aspect 24: The method of aspect 23, wherein the indication comprises a MDT alignment message, a trace reference indication associated with the one or more MDT measurements, or both.

Aspect 25: The method of any of aspects 22 through 24, further comprising: receiving the QMC start indication at a start of a first QoE measurement of the set; and receiving the QMC end indication at a last QoE measurement of the set based at least in part on the association between the one or more QoE measurement references and the one or more MDT measurements.

Aspect 26: The method of any of aspects 17 through 25, further comprising: receiving a UE capability message that indicates a capability of the UE to transmit the start indication, the end indication, or both.

Aspect 27: The method of any of aspects 17 through 26, wherein the first control message comprises a first RRC message.

Aspect 28: The method of any of aspects 17 through 27, further comprising: receiving the start indication and the end indication via a UE application layer measurement report RRC message.

Aspect 29: The method of any of aspects 17 through 28, wherein the second control message comprises a RRC reconfiguration message.

Aspect 30: The method of any of aspects 17 through 29, wherein the indicator flag comprises a binary indicator, a value of the binary indicator associates the one or more QoE measurement references with the one or more MDT measurements.

Aspect 31: An apparatus for wireless communication at a UE, comprising a processor; memory coupled with the processor; and instructions stored in the memory and executable by the processor to cause the apparatus to perform a method of any of aspects 1 through 16.

Aspect 32: An apparatus for wireless communication at a UE, comprising at least one means for performing a method of any of aspects 1 through 16.

Aspect 33: A non-transitory computer-readable medium storing code for wireless communication at a UE, the code comprising instructions executable by a processor to perform a method of any of aspects 1 through 16.

Aspect 34: An apparatus for wireless communication at a network entity, comprising a processor: memory coupled with the processor; and instructions stored in the memory and executable by the processor to cause the apparatus to perform a method of any of aspects 17 through 30.

Aspect 35: An apparatus for wireless communication at a network entity, comprising at least one means for performing a method of any of aspects 17 through 30.

Aspect 36: A non-transitory computer-readable medium storing code for wireless communication at a network entity, the code comprising instructions executable by a processor to perform a method of any of aspects 17 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a first control message comprising a quality of experience measurement configuration that indicates one or more quality of experience measurement references for the UE to perform and one or more indicator flags requesting a start indication and an end indication associated with a measurement session for the one or more quality of experience measurement references;
transmitting the start indication associated with the measurement session for the one or more quality of experience measurement references based at least in part on an indicator flag of the one or more indicator flags being set for the measurement session;
receiving, based at least in part on the start indication, a second control message comprising a minimization of drive test measurement configuration that indicates one or more minimization of drive test measurements for the UE to perform in addition to the one or more quality of experience measurement references; and
transmitting the end indication associated with the measurement session based at least in part on performing measurements for the one or more quality of experience measurement references and the one or more minimization of drive test measurements.

2. The method of claim 1, further comprising:
receiving a single indicator flag for a single quality of experience measurement reference; and
transmitting both the start indication and the end indication for the single quality of experience measurement reference in accordance with the single indicator flag.

3. The method of claim 1, further comprising:
receiving the one or more indicator flags for a subset of the one or more quality of experience measurement references, the subset of the one or more quality of experience measurement references being associated with the one or more minimization of drive test measurements; and
transmitting both the start indication and the end indication for the subset of the one or more quality of experience measurement references in accordance with the received one or more indicator flags.

4. The method of claim 1, further comprising:
receiving the one or more indicator flags for each of the one or more quality of experience measurement references; and
transmitting both the start indication and the end indication for each of the one or more quality of experience measurement references in accordance with the received one or more indicator flags.

5. The method of claim 1, further comprising:
receiving a first indicator flag applicable to each of the one or more quality of experience measurement references and an second indicator flag applicable to a single quality of experience measurement reference of the one or more quality of experience measurement references; and
transmitting both the start indication and the end indication for each of the one or more quality of experience measurement references in accordance with the first indicator flag.

6. The method of claim 1, further comprising:
transmitting the one or more indicator flags from an access stratum layer of the UE to an application layer of the UE via an attention command comprising the quality of experience measurement configuration based at least in part on receiving the one or more indicator flags from a network entity.

7. The method of claim 1, further comprising:
transmitting both the start indication and the end indication from an application layer of the UE to an access stratum layer of the UE based at least in part on the received one or more indicator flags, wherein transmitting both the start indication and the end indication to a network entity is based at least in part on transmitting the start indication and the end indication from the application layer of the UE to the access stratum layer of the UE.

8. The method of claim 1, wherein the start indication comprises a quality of experience measurement collection (QMC) start indication and the end indication comprises a QMC end indication, the method further comprising:
transmitting the QMC start indication to indicate a set of quality of experience measurement references that are associated with the one or more minimization of drive test measurements;
performing the one or more quality of experience measurement references and the associated one or more minimization of drive test measurements in accordance with the QMC start indication; and
transmitting the QMC end indication based at least in part on the performing.

9. The method of claim 8, further comprising:
receiving an indication that the set of quality of experience measurement references are associated with the one or more minimization of drive test measurements.

10. The method of claim 9, wherein the indication comprises a minimization of drive test alignment message, a trace reference indication associated with the one or more minimization of drive test measurements, or both.

11. The method of claim 8, further comprising:
transmitting the QMC start indication at a start of a first quality of experience measurement of the set;
performing the one or more quality of experience measurement references and the one or more minimization of drive test measurements in accordance with the association; and
transmitting the QMC end indication at a last quality of experience measurement of the set based at least in part on the association between the one or more quality of experience measurement references and the one or more minimization of drive test measurements.

12. The method of claim 1, further comprising:
transmitting a UE capability message that indicates a capability of the UE to transmit the start indication, the end indication, or both.

13. The method of claim 1, wherein the first control message comprises a first radio resource control message.

14. The method of claim 1, further comprising:
transmitting the start indication and the end indication via a UE application layer measurement report radio resource control message.

15. The method of claim 1, wherein the second control message comprises a radio resource control reconfiguration message.

16. The method of claim 1, wherein:
the indicator flag comprises a binary indicator, and
a value of the binary indicator associates the one or more quality of experience measurement references with the one or more minimization of drive test measurements.

17. A method for wireless communication at a network entity, comprising:
transmitting a first control message comprising a quality of experience measurement configuration that indicates one or more quality of experience measurement references for a user equipment (UE) to perform and one or more indicator flags requesting a start indication and an end indication associated with a measurement session for the one or more quality of experience measurement references;
receiving the start indication associated with the measurement session for the one or more quality of experience measurement references based at least in part on an indicator flag of the one or more indicator flags being set for the measurement session;
transmitting, based at least in part on the start indication, a second control message comprising a minimization of drive test measurement configuration that indicates one or more minimization of drive test measurements for the UE to perform in addition to the one or more quality of experience measurement references; and
receiving the end indication associated with the measurement session and a measurement report comprising the one or more quality of experience measurement references and the one or more minimization of drive test measurements.

18. The method of claim 17, further comprising:
transmitting a single indicator flag for a single quality of experience measurement reference; and
receiving both the start indication and the end indication for the single quality of experience measurement reference in accordance with the single indicator flag.

19. The method of claim 17, further comprising:
transmitting the one or more indicator flags indicating a subset of the one or more quality of experience measurement references being associated with the one or more minimization of drive test measurements; and
receiving both the start indication and the end indication for the subset of the one or more quality of experience measurement references in accordance with the received one or more indicator flags.

20. The method of claim 17, further comprising:
transmitting the one or more indicator flags for each of the one or more quality of experience measurement references; and
receiving both the start indication and the end indication for each of the one or more quality of experience measurement references in accordance with the received one or more indicator flags.

21. The method of claim 17, further comprising:
transmitting a first indicator flag applicable to each of the one or more quality of experience measurement references and an second indicator flag applicable to a single quality of experience measurement reference of the one or more quality of experience measurement references; and
receiving both the start indication and the end indication for each of the one or more quality of experience measurement references in accordance with the first indicator flag.

22. The method of claim 17, wherein the start indication comprises a quality of experience measurement collection (QMC) start indication and the end indication comprises a QMC end indication, the method further comprising:
receiving the QMC start indication that indicates an association between a set of quality of experience measurement references and the one or more minimization of drive test measurements; and
receiving the QMC end indication and the measurement report based at least in part on the association.

23. The method of claim 22, further comprising:
transmitting an indication that the set of quality of experience measurement references are associated with the one or more minimization of drive test measurements.

24. The method of claim 23, wherein the indication comprises a minimization of drive test alignment message, a trace reference indication associated with the one or more minimization of drive test measurements, or both.

25. The method of claim 22, further comprising:
receiving the QMC start indication at a start of a first quality of experience measurement of the set; and
receiving the QMC end indication at a last quality of experience measurement of the set based at least in part on the association between the one or more quality of experience measurement references and the one or more minimization of drive test measurements.

26. The method of claim 17, further comprising:
receiving a UE capability message that indicates a capability of the UE to transmit the start indication, the end indication, or both.

27. The method of claim 17, wherein the first control message comprises a first radio resource control message.

28. The method of claim 17, further comprising:
receiving the start indication and the end indication via a UE application layer measurement report radio resource control message.

29. The method of claim 17, wherein the second control message comprises a radio resource control reconfiguration message.

30. The method of claim 17, wherein:
the indicator flag comprises a binary indicator, and
a value of the binary indicator associates the one or more quality of experience measurement references with the one or more minimization of drive test measurements.

31. An apparatus for wireless communication at a user equipment (UE), comprising:
a processor; and
a memory coupled with the processor, wherein the memory comprises instructions executable by the processor to cause the apparatus to:
receive a first control message comprising a quality of experience measurement configuration that indicates one or more quality of experience measurement references for the UE to perform and one or more indicator flags requesting a start indication and an end indication associated with a measurement session for the one or more quality of experience measurement references;
transmit the start indication associated with the measurement session for the one or more quality of experience measurement references based at least in part on an indicator flag of the one or more indicator flags being set for the measurement session;
receive, based at least in part on the start indication, a second control message comprising a minimization of drive test measurement configuration that indicates one or more minimization of drive test measurements for the UE to perform in addition to the one or more quality of experience measurement references; and
transmit the end indication associated with the measurement session based at least in part on performing measurements for the one or more quality of experience measurement references and the one or more minimization of drive test measurements.

32. An apparatus for wireless communication at a network entity, comprising:
a processor; and
a memory coupled with the processor, wherein the memory comprises instructions executable by the processor to cause the apparatus to:
transmit a first control message comprising a quality of experience measurement configuration that indicates one or more quality of experience measurement references for a user equipment (UE) to perform and one or more indicator flags requesting a start indication and an end indication associated with a measurement session for the one or more quality of experience measurement references;
receive the start indication associated with the measurement session for the one or more quality of experience measurement references based at least in part on an indicator flag of the one or more indicator flags being set for the measurement session;
transmit, based at least in part on the start indication, a second control message comprising a minimization of drive test measurement configuration that indicates one or more minimization of drive test measurements for the UE to perform in addition to the one or more quality of experience measurement references; and
receive the end indication associated with the measurement session and a measurement report comprising the one or more quality of experience measurement references and the one or more minimization of drive test measurements.
